(19) United States
(12) Patent Application Publication
(10) Pub. No.: US 2025/0110222 A1
(43) Pub. Date: Apr. 3, 2025

(54) RANGING APPARATUS, RANGING SYSTEM, MOVING BODY, AND DEVICE

(71) Applicant: CANON KABUSHIKI KAISHA, Tokyo (JP)

(72) Inventor: DAIKI SHIRAHIGE, Kanagawa (JP)

(21) Appl. No.: 18/883,111

(22) Filed: Sep. 12, 2024

(30) Foreign Application Priority Data
Sep. 29, 2023 (JP) 2023-169491

(51) Int. Cl. G01S 7/487; G01S 7/4863; G01S 7/4865; G01S 17/10; G01S 17/86; G01S 17/931

(52) U.S. Cl. CPC G01S 7/4873; G01S 7/4863; G01S 7/4866; G01S 17/10; G01S 17/86; G01S 17/931

(57) ABSTRACT

A ranging apparatus includes a light-emitting unit configured to irradiate an object with light; a plurality of pixels; a microlens that is arranged on the plurality of pixels and that is shared by the plurality of pixels; a first ranging unit configured to acquire a distance to the object, based on a time it takes to receive reflected light of the light radiated by the light-emitting unit; and a second ranging unit configured to acquire a distance to the object, based on a difference among respective outputs of the plurality of pixels having received the reflected light.

### BACKGROUND

### Technical Field

The present invention relates to a ranging apparatus, a ranging system, a moving body, and a device.

### Description of the Related Art

A ToF (Time of Flight) system and a phase difference system using a DAF (Dual Pixel Auto Focus) function are known as systems for measuring a distance to an object. The ToF system is a system that acquires a distance to an object, based on the time it takes for radiated light to return after being reflected by the object. The phase difference system is a system that acquires a distance to an object, based on a phase difference between signals output from two pixels included in an imaging element having a DAF function.

Japanese Patent Application Laid-open No. 2022-063415 discloses a technique of measuring distances using a direct ToF system (dToF system) and an indirect ToF system (iToF system).

However, since accuracy of ranging according to the ToF system depends on reflectance of an object, i.e., a ranging object, sufficient ranging accuracy may be difficult to attain even when measuring distances according to the dToF system and the iToF system.

### SUMMARY

The present invention provides a ranging apparatus which implements ranging according to a ToF system and a phase difference system and which improves ranging accuracy.

A first aspect of the present invention provides a ranging apparatus including: a light-emitting unit configured to irradiate an object with light; a plurality of pixels; a microlens that is arranged on the plurality of pixels and that is shared by the plurality of pixels; a first ranging unit configured to acquire a distance to the object, based on a time it takes to receive reflected light of the light radiated by the light-emitting unit; and a second ranging unit configured to acquire a distance to the object, based on a difference among respective outputs of the plurality of pixels having received the reflected light.

A second aspect of the present invention provides a ranging system including: the ranging apparatus described above; and a signal processing unit configured to process a signal output by the ranging apparatus.

A third aspect of the present invention provides a moving body including the ranging apparatus described above, the moving body including a control unit configured to control movement of the moving body using information on a distance to the object that is acquired by the ranging apparatus.

A fourth aspect of the present invention provides a device including: the ranging apparatus described above; and at least any of an optical apparatus that corresponds to the ranging apparatus, a control apparatus that controls the ranging apparatus, a processing apparatus that processes a signal output from the ranging apparatus, a display apparatus that displays information obtained by the ranging apparatus, a storage apparatus that stores information obtained by the ranging apparatus, and a mechanical apparatus that operates based on information obtained by the ranging apparatus.

Further features of the present invention will become apparent from the following description of exemplary embodiments with reference to the attached drawings.

### BRIEF DESCRIPTION OF THE DRAWINGS

FIG. 1 is a schematic view of a ranging apparatus;

FIG. 2 is a schematic view of a pixel substrate of the ranging apparatus;

FIG. 3 is a schematic view of a circuit substrate of the ranging apparatus;

FIGS. 4A and 4B represent a configuration example of a pixel circuit of the ranging apparatus;

FIG. 5 is a schematic view showing drive of the pixel substrate of the ranging apparatus;

FIG. 6 is a plan view of a pixel of the ranging apparatus;

FIG. 7 is an A-A′ sectional view of the pixel of the ranging apparatus;

FIG. 8 is a B-B′ sectional view of the pixel of the ranging apparatus;

FIG. 9 is a C-C′ sectional view of the pixel of the ranging apparatus;

FIG. 10 is a functional block diagram of the ranging apparatus;

FIGS. 11A and 11B are diagrams illustrating a histogram that represents an intensity of reflected light;

FIGS. 12A to 12C are diagrams illustrating ranging by the phase difference system;

FIG. 13 is a flow chart illustrating ranging processing;

FIGS. 14A and 14B are diagrams illustrating a timing jitter;

FIG. 15 is a diagram illustrating a ranging system according to a second embodiment;

FIG. 16A is a diagram showing a configuration of a ranging system according to a third embodiment;

FIG. 16B is a diagram showing a configuration of a moving body according to the third embodiment;

FIG. 17 is a diagram illustrating a distance image sensor according to a fourth embodiment;

FIG. 18 is a diagram illustrating an endoscopic surgery system according to a fifth embodiment;

FIGS. 19A and 19B are diagrams illustrating smart glasses according to a sixth embodiment;

FIGS. 20A and 20B are diagrams illustrating an electronic device according to a seventh embodiment;

FIG. 21 is a diagram illustrating an X-ray CT apparatus according to an eighth embodiment; and

FIG. 22 is a diagram illustrating an imaging system according to a ninth embodiment.

### DESCRIPTION OF THE EMBODIMENTS

The modes described below are for implementing technical concepts of the present invention and are not intended to limit the present invention. Note that sizes and positional relationships of members shown in each of the drawings may sometimes be exaggerated for the sake of better understanding. In the following description, same components may be denoted by same numerals and descriptions thereof may be omitted.

Hereinafter, embodiments of the present invention will be described in detail with reference to the drawings. In the following description, terms that indicate a specific direction or a position (for example, “up”, “down”, “right”, “left” and other terms that contain these terms) will be used as necessary. Such terms are used for facilitating understanding of the embodiments with reference to the drawings and the meanings of the terms are not intended to limit the technical scope of the present invention in any way whatsoever.

In the present specification, a plan view refers to a view from a perpendicular direction with respect to a light incidence surface of a semiconductor layer. In addition, a sectional view refers to a view from a direction parallel to the light incidence surface of the semiconductor layer. When the light incidence surface of the semiconductor layer is a rough surface from a microscopic perspective, a plan view is to be defined with respect to the light incidence surface of the semiconductor layer when viewed from a macroscopic perspective.

The semiconductor layer has a first surface and a second surface which is a surface on an opposite side to the first surface and to which light is incident. In the present specification, a depth direction is a direction from the first surface of the semiconductor layer on which an avalanche photodiode (APD) is arranged toward the second surface of the semiconductor layer. Hereinafter, the “first surface” may be referred to as a “front surface” and the “second surface” may be referred to as a “rear surface”. A “depth” of a given point or a given region in the semiconductor layer means a distance of the point or the region from the first surface (front surface). When there are a point (or a region) Z1 of which a distance (depth) from the first surface is d1 and a point (or a region) Z2 of which a distance (depth) from the first surface is d2 and d1>d2 is satisfied, expressions such as “Z1 is deeper than Z2” and “Z2 is shallower than Z1” may be used. In addition, when there is a point (or a region) Z3 of which a distance (depth) from the first surface is d3 and d1>d3>d2 is satisfied, expressions such as “Z3 is at a depth between Z1 and Z2” and “Z3 is between Z1 and Z2 in the depth direction” may be used.

In the following description, an anode of an avalanche photodiode (APD) is to have a fixed potential and a signal is extracted from a cathode side. Therefore, a first conductivity type semiconductor region having, as a majority carrier, charges with a same polarity as a signal charge is an N-type semiconductor region and a second conductivity type semiconductor region having, as a majority carrier, charges with a different polarity from the signal charge is a P-type semiconductor region. It should be noted that the present invention holds true even in cases where the cathode of an APD is to have a fixed potential and a signal is extracted from the anode side. In this case, the first conductivity type semiconductor region having, as a majority carrier, charges with a same polarity as a signal charge is a P-type semiconductor region and the second conductivity type semiconductor region having, as a majority carrier, charges with a different polarity from the signal charge is an N-type semiconductor region. While a case where one of the nodes of an APD is to have a fixed potential will be described below, alternatively, potentials of both nodes may fluctuate.

In the present specification, simply using the term “impurity concentration” means a net impurity concentration after subtracting an amount compensated by inverse conductivity-type impurities. In other words, an “impurity concentration” refers to a NET doping concentration. A region in which a P-type additive impurity concentration is higher than an N-type additive impurity concentration is a P-type semiconductor region. Conversely, a region in which an N-type additive impurity concentration is higher than a P-type additive impurity concentration is an N-type semiconductor region.

In addition, a connection between elements of a circuit may be described in the following embodiments. In this case, unless otherwise noted, elements of interest will be considered being electrically connected even if another element is interposed between the elements of interest. For example, let us assume that an element A is connected to one of a plurality of nodes of a capacitative element C and an element B is connected to another node of the capacitative element C. Even in this case, the element A and the element B will be considered being electrically connected unless otherwise noted. Furthermore, when elements are connected to each other without any interposed elements, the elements may be described as being directly connected to each other. In the example described above, when another element is not provided between the element A and the capacitative element C, the element A and the capacitative element C can be described as being directly connected to each other.

Metal members such as wiring and pads described in the present specification may be constituted of an elemental metal made of a single element or may be a mixture (alloy). For example, a wiring described as a copper wiring may be constituted by elemental copper or may be constructed to mainly contain copper but also contain other components. In addition, for example, a pad to be connected to an external terminal may be constituted by elemental aluminum or may be constructed to mainly contain aluminum but also contain other components. The copper wiring and the aluminum pad described above are merely examples and may be changed to various metals.

In addition, the wiring and the pad described above are examples of metal members that are used in a photoelectric conversion apparatus and can also be applied to other metal members.

In the respective embodiments presented below, a ranging apparatus (an apparatus for focus detection, distance measurement using ToF (Time of Flight), and the like) will be mainly described as an example of a photoelectric conversion apparatus. However, the respective embodiments are not limited to a ranging apparatus and are also applicable to other examples of photoelectric conversion apparatuses. Such examples include an imaging apparatus and a photometric apparatus (an apparatus for measuring an amount of incident light and the like).

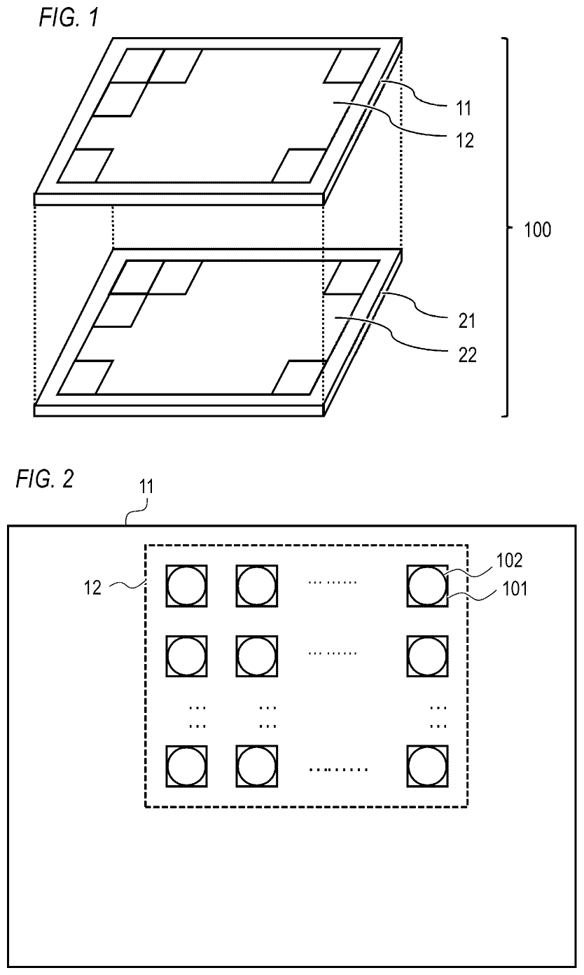

A common configuration shared by respective embodiments of a photoelectric conversion apparatus and a driving method thereof according to the present invention will be described with reference to FIGS. 1 to 5.

FIG. 1 is a diagram showing a configuration of a photoelectric conversion apparatus 100 according to an embodiment of the present invention. Hereinafter, a case where the photoelectric conversion apparatus 100 is a stacked photoelectric conversion apparatus will be described as an example. Specifically, a photoelectric conversion apparatus constructed by stacking two substrates, namely, a sensor substrate 11 and a circuit substrate 21 and electrically connecting the substrates will be described as an example. However, photoelectric conversion apparatuses are not limited thereto. For example, the photoelectric conversion apparatus may be a photoelectric conversion apparatus in which components of the sensor substrate 11 and components of the circuit substrate 21 described below are arranged on a common semiconductor layer. Hereinafter, a photoelectric conversion apparatus in which the components of the sensor substrate 11 and the components of the circuit substrate 21 are arranged on a common semiconductor layer will also be referred to as a non-stacked photoelectric conversion apparatus.

The sensor substrate 11 includes a first semiconductor layer that includes a photoelectric-conversion element 102 to be described later and a first wiring structure. The circuit substrate 21 includes a second semiconductor layer that includes a circuit such as a signal processing unit 103 or the like to be described later and a second wiring structure. The photoelectric conversion apparatus 100 is constructed by stacking the second semiconductor layer, the second wiring structure, the first wiring structure, and the first semiconductor layer in this order.

FIG. 1 illustrates a back-side illuminated photoelectric conversion apparatus in which light is incident from a second surface (rear surface) and the circuit substrate 21 is arranged on a first surface (front surface) that is a surface on an opposite side to the second surface. In the case of a non-stacked photoelectric conversion apparatus, a surface on a side where a transistor of a signal processing circuit is arranged is referred to as a first surface. In the case of a front-side illuminated photoelectric conversion apparatus, the front surface is the second surface (light incidence surface) and the rear surface is the first surface.

While the sensor substrate 11 and the circuit substrate 21 will be described below as being diced chips, the substrates are not limited to chips. For example, each substrate may be a wafer. In addition, each substrate may be stacked in a wafer state and subsequently diced or each chip may be stacked and joined after being made into chips.

A pixel region 12 is arranged on the sensor substrate 11 and a circuit region 22 for processing a signal detected by the pixel region 12 is arranged on the circuit substrate 21.

FIG. 2 is an arrangement diagram of the sensor substrate 11. Pixels 101 that include the photoelectric-conversion element 102 including an avalanche photodiode (APD) are arrayed in a two-dimensional pattern to form the pixel region 12.

While the pixel 101 is typically a pixel for forming an image, when used for TOF (Time of Flight), an image need not necessarily be formed. In other words, the pixel 101 may be a pixel for measuring a time of arrival of light and a light amount.

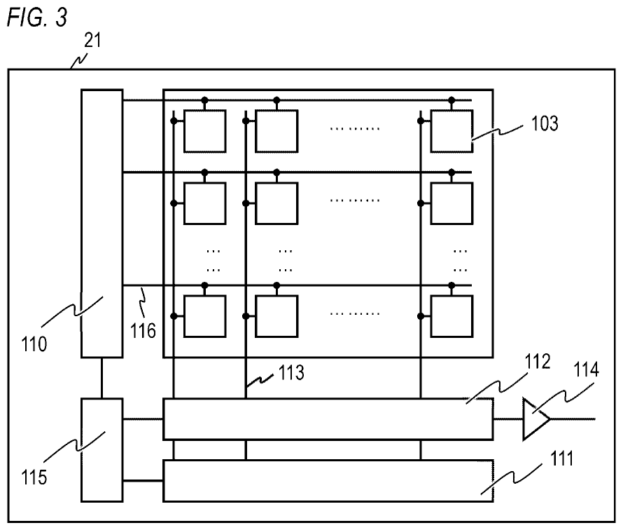

FIG. 3 is a configuration diagram of the circuit substrate 21. The circuit substrate 21 includes the signal processing unit 103 that processes a charge having been photoelectrically converted by the photoelectric-conversion element 102 shown in FIG. 2, a readout circuit 112, a control pulse generating unit 115, a horizontal scan circuit unit 111, a signal line 113, a vertical scan circuit unit 110, a drive line 116, and an output circuit 114.

The photoelectric-conversion element 102 shown in FIG. 2 and the signal processing unit 103 shown in FIG. 3 are electrically connected via a connecting wiring provided for each pixel.

The vertical scan circuit unit 110 receives a control pulse supplied from the control pulse generating unit 115 and supplies the control pulse to each pixel via the drive line 116. A logic circuit such as a shift register or an address decoder is used in the vertical scan circuit unit 110.

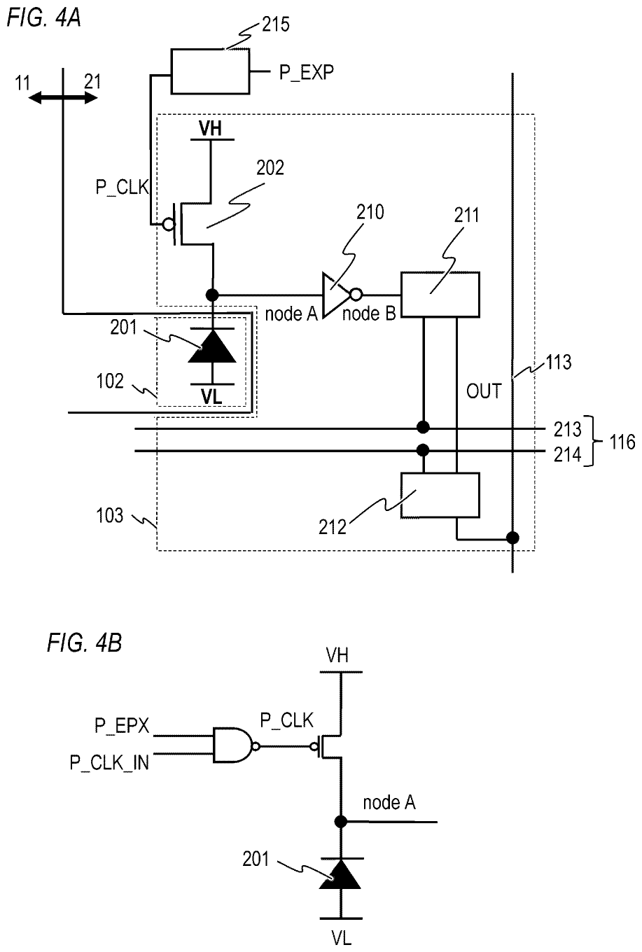

The control pulse generating unit 115 includes a signal generating unit 215 that generates a control signal P_CLK of a switch to be described later. As will be described later, the signal generating unit 215 generates a pulse signal that controls the switch. For example, the signal generating unit 215 may commonly generate the control signal P_CLK with respect to a plurality of pixels in the pixel region as shown in FIG. 4A or generate the control signal P_CLK for each pixel as shown in FIG. 4B. When commonly generating the control signal P_CLK, the control signal P_CLK is commonly generated by associating, with an exposure period, at least any one of a period, the number of pulses, and a pulse width of a pulse signal P_EXP that controls an exposure period. In addition, when controlling the control signal P_CLK for each pixel, the signal can be generated using both an input signal P_CLK_IN that is output from the control pulse generating unit 115 and the signal P_EXP that controls the exposure period. For example, the control pulse generating unit 115 preferably includes a divider circuit. Accordingly, simple control can be realized and an increase in the number of elements can be suppressed.

A signal output from the photoelectric-conversion element 102 of each pixel is processed by the signal processing unit 103. The signal processing unit 103 is provided with a counter, a memory, and the like and a digital value is stored in the memory.

The horizontal scan circuit unit 111 inputs a control pulse for sequentially selecting each row to the signal processing unit 103 in order to read a signal from the memory of each pixel that stores a digital signal.

For each selected row, a signal is output to the signal line 113 from the signal processing unit 103 of the pixel having been selected by the vertical scan circuit unit 110.

The signal output to the signal line 113 is output to an external recording unit or a signal processing unit of the photoelectric conversion apparatus 100 via the output circuit 114.

In FIG. 2, an array of the pixels 101 in the pixel region 12 may be arranged one-dimensionally. A function of the signal processing unit 103 need not necessarily be provided in each and every pixel 101 and, for example, a single signal processing unit 103 may be shared by a plurality of pixels 101 and signal processing may be performed sequentially.

FIGS. 4A and 4B are examples of a block diagram including the equivalent circuit shown in FIGS. 2 and 3. FIG. 4A represents an example in which the signal generating unit 215 is commonly provided with respect to a plurality of pixels and FIG. 4B represents an example in which the control signal P_CLK can be controlled for each pixel. FIG. 4A will be described.

In FIG. 4A, the photoelectric-conversion element 102 including an APD 201 is provided in the sensor substrate 11 and other members are provided in the circuit substrate 21.

The APD 201 generates a charge pair in accordance with incident light by photoelectric conversion. A voltage VL (first voltage) is supplied to an anode of the APD 201. In addition, a voltage VH (second voltage) that is higher than the voltage VL supplied to the anode is supplied to a cathode of the APD 201. The anode and the cathode are supplied with voltages with a reverse bias that causes the APD 201 to perform an avalanche multiplication operation. By creating a state where such voltages are supplied, a charge created by the incident light causes avalanche multiplication and an avalanche current is created.

When voltage of a reverse bias is supplied, the APD has a Geiger mode in which the APD operates at a potential difference between the anode and the cathode that is larger than a breakdown voltage and a linear mode in which the APD operates at a potential difference between the anode and the cathode that is in the vicinity of or smaller than the breakdown voltage. The APD operated in the Geiger mode is referred to as a SPAD. For example, the voltage VL (first voltage) is −30 V and the voltage VH (second voltage) is 1 V. The APD 201 may be operated either in the linear mode or in the Geiger mode. In the case of a SPAD, the potential difference increases as compared to an APD in the linear mode and a voltage-resistance effect becomes prominent.

A switch 202 is connected to a power line and the APD 201 to which the drive voltage VH is supplied. The switch 202 is connected to one node among the anode and the cathode of the APD 201. In addition, the switch 202 performs switching between a first potential difference at which the potential difference between the anode and the cathode of the APD 201 is avalanche-multiplied and a second potential difference at which the potential difference between the anode and the cathode of the APD 201 is not avalanche-multiplied. Hereinafter, switching from the second potential difference to the first potential difference will also be referred to as turning the switch 202 on and switching from the first potential difference to the second potential difference will also be referred to as turning the switch 202 off. The switch 202 functions as a quenching element. The switch 202 functions as a load circuit (quenching circuit) during signal multiplication due to the avalanche multiplication and acts to suppress the voltage to be supplied to the APD 201 to suppress avalanche multiplication (a quenching operation). In addition, by causing a current corresponding to the voltage drop due to the quenching operation to flow, the switch 202 acts to return the voltage supplied to the APD 201 to the drive voltage VH (a recharging operation). In other words, the switch 202 functions as a control circuit that controls an occurrence of avalanche multiplication in the APD 201.

The switch 202 can be constituted of, for example, a MOS transistor. The control signal P_CLK of the switch 202 supplied from the signal generating unit 215 is applied to a gate electrode of the MOS transistor that constitutes the switch 202. In the present embodiment, on and off states of the switch 202 are controlled by controlling an applied voltage to the gate electrode of the switch 202.

The signal processing unit 103 includes a waveform shaping unit 210, a counter circuit 211, and a selection circuit 212. In the present specification, the signal processing unit 103 need only include at least any one of the waveform shaping unit 210, the counter circuit 211, and the selection circuit 212.

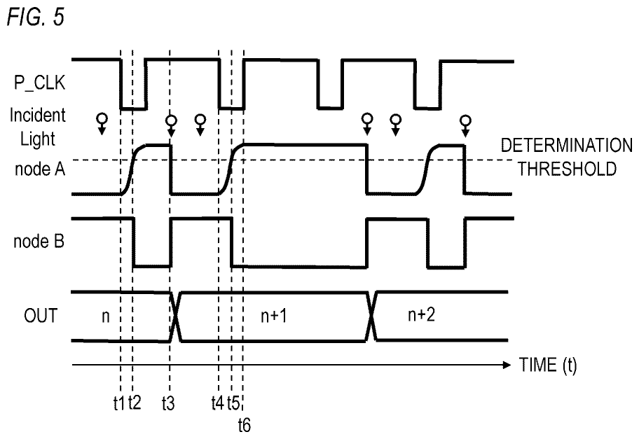

The waveform shaping unit 210 shapes a potential change of the cathode of the APD 201 that is obtained upon photon detection and outputs a pulse signal. A node on an input side of the waveform shaping unit 210 will be referred to as a node A and a node on an output side of the waveform shaping unit 210 will be referred to as a node B. The waveform shaping unit 210 varies an output potential from node B depending on whether an input potential to node A is equal to or higher than a predetermined value or lower than the predetermined value. For example, in FIG. 5, when the input potential to node A becomes a high potential that is equal to or higher than a determination threshold, the output potential from node B changes to a low level. In addition, when the input potential to node A becomes a low potential that is lower than the determination threshold, the output potential from node B changes to a high level. For example, an inverter circuit is used as the waveform shaping unit 210. While an example in which a single inverter is used as the waveform shaping unit 210 is shown in FIG. 4A, a circuit in which a plurality of inverters are connected in series may be used or another circuit with a waveform shaping effect may be used.

While a quenching operation and a recharging operation using the switch 202 can be performed in accordance with an avalanche multiplication in the APD 201, depending on a photon detection timing, a charge generated in the APD 201 may not be determined as an output signal. For example, let us assume a case where an avalanche multiplication has occurred in the APD 201, node A has changed to a low level, and a recharging operation is being performed. Generally, the determination threshold of the waveform shaping unit 210 is set to a higher potential than a potential difference at which an avalanche multiplication occurs in the APD 201. When photons are incident to the APD 201 in a state where, due to a recharging operation, the potential of node A is lower than the determination threshold and the potential can be avalanche-multiplied in the APD 201, an avalanche multiplication occurs in the APD 201 and a voltage of node A drops. In other words, since the potential of node A drops under a lower voltage than the determination threshold, a potential change that straddles the determination threshold does not occur and an output potential from node B does not change. Therefore, a photon detection is no longer determined as a signal despite an occurrence of an avalanche multiplication. In particular, under a high luminance, since photons are consecutively incident to the APD 201 in a short period of time under a high luminance, incident light is less likely to be determined as a signal. Accordingly, the number of actually incident photons and an output signal more readily diverge from each other despite being under a high luminance.

In contrast, by applying the control signal P_CLK to the switch 202 and switching between the on-state and the off-state of the switch 202, a determination of a signal can be made even when photons are consecutively incident to the APD 201 in a short period of time. In FIG. 5, an example in which the control signal P_CLK is a pulse signal with a repetition period will be described. In other words, a mode in which the on-state and the off-state of the switch 202 are switched by a predetermined clock frequency will be described in FIG. 5. However, an effect of suppressing an increase in power consumption of the photoelectric conversion apparatus 100 can be obtained even if the pulse signal is not a signal with a repetition period.

The counter circuit 211 counts pulse signals output from the waveform shaping unit 210 and stores a count value. In addition, when a control pulse pRES is supplied via a drive line 213, the signals stored in the counter circuit 211 are reset.

The selection circuit 212 is supplied with a control pulse pSEL via a drive line 214 shown in FIG. 4A from the vertical scan circuit unit 110 shown in FIG. 3 and switches between electric connection and non-connection of the counter circuit 211 and the signal line 113. For example, the selection circuit 212 includes a buffer circuit for outputting signals and the like.

A switch such as a transistor may be arranged between the switch 202 and the APD 201 and between the photoelectric-conversion element 102 and the signal processing unit 103 to switch between electric connection and non-connection. In a similar manner, supply of the voltage VH or the voltage VL to be supplied to the photoelectric-conversion element 102 may be electrically switched using a switch such as a transistor.

A configuration using the counter circuit 211 has been described in the present embodiment. However, the photoelectric conversion apparatus 100 which acquires a pulse detection timing using a Time to Digital Converter (hereinafter, TDC) and a memory in place of the counter circuit 211 may be adopted. In this case, a generation timing of a pulse signal output from the waveform shaping unit 210 is converted into a digital signal by the TDC. In order to measure a timing of a pulse signal, the TDC is supplied with a control pulse pREF (a referential signal) via a drive line from the vertical scan circuit unit 110 shown in FIG. 3. Using the control pulse pREF as a reference, the TDC acquires, as a digital signal, a value when an input timing of a signal output from each pixel is considered a relative time.

FIG. 5 is a diagram schematically showing a relationship among the control signal P_CLK of the switch, the potential of node A, the potential of node B, and the output signal. In the present embodiment, a state where the drive voltage VH is hardly supplied to the APD 201 is created when the control signal P_CLK is at a high level and a state where the drive voltage VH is supplied to the APD 201 is created when the control signal P_CLK is at a low level. The high level of the control signal P_CLK is, for example, 1 V, and the low level of the control signal P_CLK is, for example, 0 V. The switch is turned off when the control signal P_CLK is at the high level and the switch is turned on when the control signal P_CLK is at the low level. A resistance value of the switch when the control signal P_CLK is at the high level is higher than a resistance value of the switch when the control signal P_CLK is at the low level. When the control signal P_CLK is at the high level, since a recharging operation is less likely to be performed even if an avalanche multiplication occurs in the APD 201, the potential supplied to the APD 201 becomes equal to or lower than the breakdown voltage of the APD 201. Therefore, the avalanche multiplication operation in the APD 201 stops.

As shown in FIG. 4A, preferably, the switch 202 is constituted of one transistor and a quenching operation and a recharging operation are performed with one transistor. Accordingly, the number of circuits can be reduced as compared to a case where a quenching operation and a recharging operation are respectively performed by different circuit elements. In particular, when each pixel includes a counter circuit and an SPAD signal is read for each pixel, a circuit area used for a switch is preferably reduced in order to arrange the counter circuits and an effect produced by constituting the switch 202 with one transistor becomes prominent.

At time t1, the control signal P_CLK changes from the high level to the lower level, the switch is turned on, and a recharging operation of the APD 201 is started. Accordingly, a potential of the cathode of the APD 201 makes a transition to a high level. In addition, a state is created where the potential difference between potentials applied to the anode and the cathode of the APD 201 can be avalanche-multiplied. The potential of the cathode is the same as node A. Therefore, when the potential of the cathode makes a transition from the low level to the high level, the potential of node A equals or exceeds the determination threshold at time t2. At this point, the pulse signal output from node B is inverted and changes from the high level to the low level. Subsequently, a state is created where a potential difference expressed as drive voltage VH-drive voltage VL is applied to the APD 201. The control signal P_CLK changes to the high level and the switch is turned off.

Next, when photons are incident to the APD 201 at time t3, an avalanche multiplication occurs in the APD 201 and the voltage of the cathode drops. In other words, the voltage of node A drops. When the amount of voltage drop further increases and a voltage difference that is applied to the APD 201 decreases, the avalanche multiplication of the APD 201 stops in a similar manner to time t2 and a voltage level of node A does not drop beyond a given constant value. When the voltage of node A becomes lower than the determination threshold during the voltage drop of node A, the voltage of node B changes from the low level to the high level. In other words, a portion of the output waveform of node A having exceeded the determination threshold is subjected to waveform shaping by the waveform shaping unit 210 and output as a signal from node B. In addition, the signal is counted by a counter circuit and a count value of a counter signal that is output from the counter circuit increases by an amount corresponding to 1 LSB.

Although photons are incident to the APD 201 between time t3 and time t4, since the switch is in the off-state and the applied voltage to the APD 201 does not create a potential difference that can be avalanche-multiplied, the voltage level of node A does not exceed the determination threshold.

At time t4, the control signal P_CLK changes from the high level to the low level and the switch is turned on. Accordingly, a current that compensates for the amount of voltage drop from the drive voltage VH flows to node A and the voltage of node A makes a transition to the original voltage level. In this case, since the voltage of node A equals or exceeds the determination threshold at time t5, the pulse signal of node B is inverted and changes from the high level to the low level.

At time t6, node A stabilizes at the original voltage level and the control signal P_CLK changes from the low level to the high level. Therefore, the switch is turned off. Hereinafter, potentials of each node, each signal line, and the like change in a similar manner according to the control signal P_CLK or incidence of photons as described above with respect to time t1 to time t6.

Hereinafter, a ranging apparatus of each embodiment to which the photoelectric conversion apparatus described above is applied will be described.

### First Embodiment

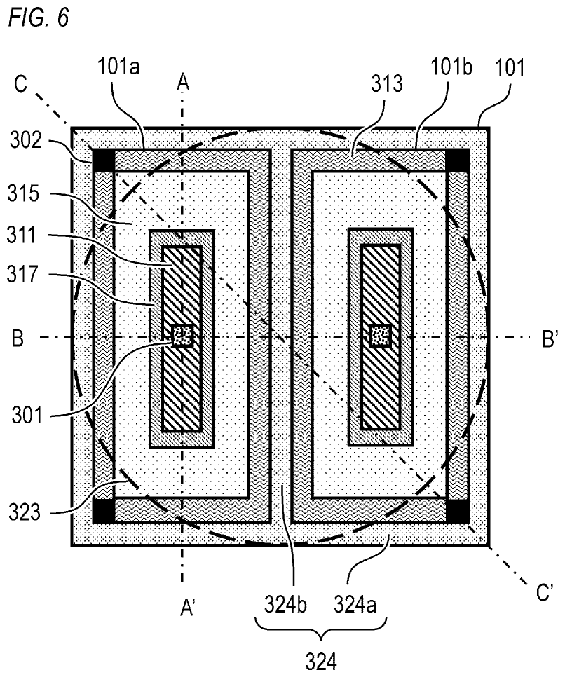

A ranging apparatus will be described with reference to FIGS. 6 to 9. FIGS. 6 to 9 illustrate a plan view and sectional views of one of a plurality of pixels 101 included in the pixel region 12. The pixel 101 includes two subpixels 101a and 101b that share one microlens 323 arranged on the pixel. Each of the subpixels 101a and 101b includes a photodiode. In the following description, the photodiodes included in the subpixels 101a and 101b are assumed to be APDs in which charges cause an avalanche multiplication. The ranging apparatus can utilize the avalanche multiplication of the APDs included in the pixels 101 to detect faint light on a single photon-level.

FIG. 6 is a plan view of the pixel 101 of the ranging apparatus. FIG. 6 illustrates a structure for describing a positional relationship in a plan view and includes structures that do not exist on a same plane. In addition, illustration of structures not used in the description will be omitted.

In the example shown in FIG. 6, the pixel 101 includes two subpixels 101a and 101b and the subpixels 101a and 101b share one microlens 323. Note that subpixels included in the pixel 101 are not limited to the two subpixels arranged in a 1 row×2 columns pattern. The pixel 101 may include four subpixels arranged in a 2 rows×2 columns pattern or may include more than four subpixels. The plurality of subpixels included in the pixel 101 share one microlens 323. When four or more subpixels are included in the pixel 101, imaging plane phase difference detection with higher accuracy can be performed due to phase difference detection being performed in a plurality of directions.

In the example shown in FIG. 6, the APD included in each of the subpixels 101a and 101b includes a first semiconductor region 311 of a first conductivity type and a second semiconductor region 312 (not illustrated) of a second conductivity type. If the APD of the subpixel 101a is referred to as a first avalanche photodiode and the APD of the subpixel 101b is referred to as a second avalanche photodiode, the first semiconductor region 311 of the first avalanche photodiode has a long axis direction and a short axis direction. In other words, the first semiconductor region of the first avalanche photodiode has a length in a first direction and a length in a second direction that is orthogonal to the first direction and the length in the first direction is longer than the length in the second direction.

Each of the APDs included in the pixel 101 includes one or more cathode electrodes 301 and one or more anode electrodes 302. The cathode electrode 301 supplies a first voltage (cathode voltage) to the first semiconductor region 311 via a first contact. A first separation portion 324a is arranged between the pixels 101 and a second separation portion 324b is arranged between the APDs. A third semiconductor region 313 of the second conductivity type is provided in a region adjacent to a separation portion 324 that includes the first separation portion 324a and the second separation portion 324b. The third semiconductor region 313 and the anode electrode 302 are electrically connected to each other via a second contact and a second voltage (anode voltage) is supplied from the anode electrode 302 to the third semiconductor region 313.

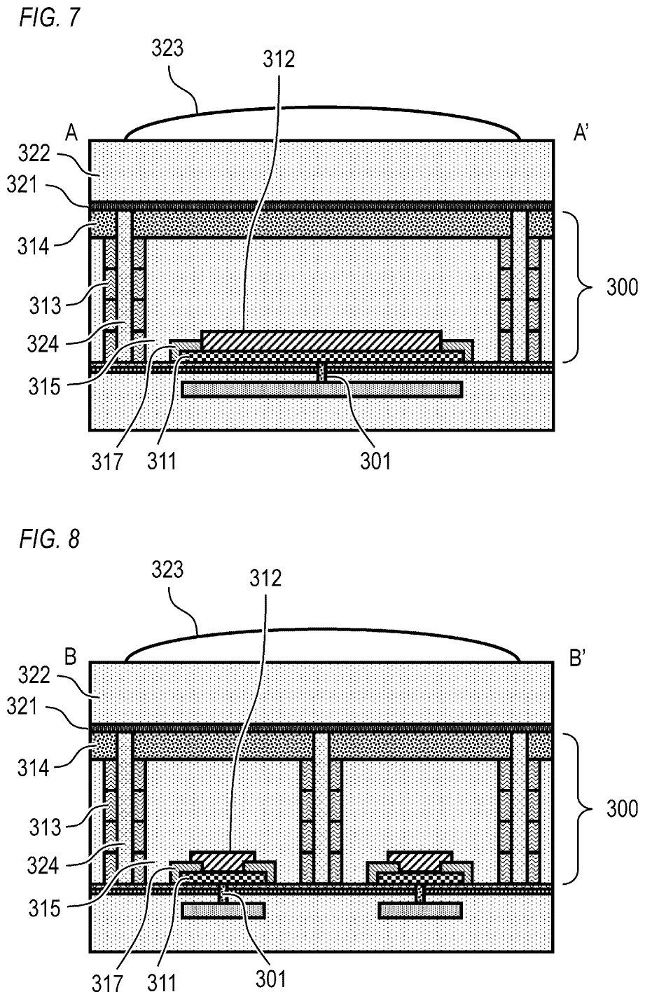

Details of each semiconductor region arranged on a semiconductor layer 300 will be described with reference to FIGS. 7 to 9. FIGS. 7 to 9 respectively show an A-A′ sectional view, a B-B′ sectional view, and a C-C′ sectional view of the pixel 101 shown in FIG. 6.

FIG. 7 shows an A-A′ sectional view of the pixel 101 shown in FIG. 6. In addition to the semiconductor layer 300, FIG. 7 shows a pinning film 321, a planarizing layer 322, and the microlens 323 formed on a substrate rear surface side and the cathode electrode 301 and a part of wirings thereof which are formed on the substrate front surface side and which are connected to the semiconductor layer 300.

As shown in FIG. 7, a seventh semiconductor region 317 of the first conductivity type is arranged around the first semiconductor region 311 and the second semiconductor region 312 of the second conductivity type is arranged adjacent in a depth direction of the first semiconductor region 311. Furthermore, a fifth semiconductor region 315 is arranged on a rear surface side of the second semiconductor region 312.

The first semiconductor region 311 and the second semiconductor region 312 form a PN junction. By applying a predetermined reverse bias voltage to the first semiconductor region 311 and the second semiconductor region 312, the APD causes an avalanche multiplication. In addition, the fifth semiconductor region 315 (for example, an epitaxial layer of the first conductivity type or an epitaxial layer of the second conductivity type) of which an impurity concentration of the second conductivity type is lower than the second semiconductor region 312 is provided in a region on a rear surface side relative to the second semiconductor region 312 in the semiconductor layer 300. Therefore, by applying a reverse bias to the PN junction portion, a depletion layer spreads toward the rear surface side of the semiconductor layer 300.

The seventh semiconductor region 317 is arranged such that at least a part thereof is in contact with an end of the first semiconductor region 311. Due to the end of the first semiconductor region 311 creating an intense electric field, an edge breakdown where a breakdown occurs at a low voltage is suppressed in the region.

A large number of dangling bonds that are unsatisfied valences of silicon are present near an interface between the separation portion 324 and the semiconductor layer 300 and there is a possibility that a dark current may be created via a defect level. In order to suppress an occurrence of the dark current, the third semiconductor region 313 of the second conductivity type is arranged so as to come into contact with the separation portion 324. For a similar reason, a fourth semiconductor region 314 of the second conductivity type is arranged on a rear surface side of the semiconductor layer 300. In addition, by forming the pinning film 321 on a rear surface-side interface of the semiconductor layer 300, a hole is induced on the side of the semiconductor layer 300 and the dark current is suppressed.

FIG. 8 shows a B-B′ sectional view of the pixel 101 shown in FIG. 6. As shown in FIG. 8, the pixel 101 is constructed such that two APDs share one microlens 323. By having a plurality of APDs share one microlens 323, a luminous flux having passed through a given region of an objective lens can be captured by each APD and a defocus amount and a direction thereof can be detected from differences between outputs of the APDs under the microlens 323. Accordingly, imaging plane phase difference automatic focusing that satisfies both imaging and phase difference detection can be realized.

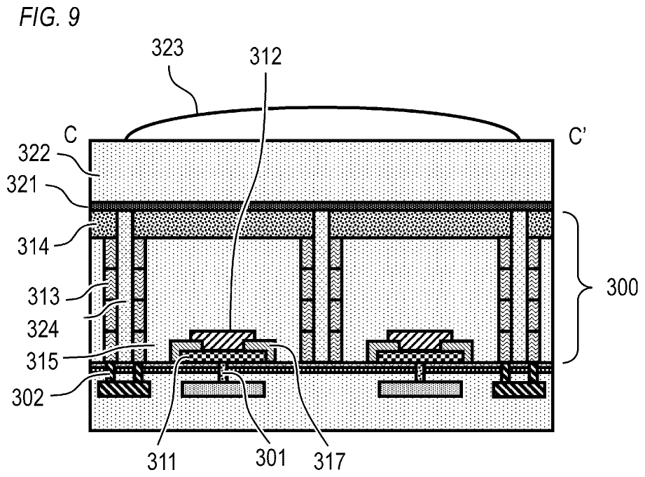

FIG. 9 shows a C-C′ sectional view of the pixel 101 shown in FIG. 6. The cathode electrode 301 and the anode electrode 302 are arranged on the front surface side of the semiconductor layer 300. The cathode electrode 301 is electrically connected to the first semiconductor region 311 via the first contact and the anode electrode 302 is electrically connected to the third semiconductor region 313 via the second contact.

FIGS. 6 and 9 show an example in which the anode electrode 302 is arranged at four corners of each of the two APDs arranged in a 1 row×2 columns pattern. The arrangement of anode electrodes 302 is not limited thereto and the anode electrodes 302 may be arranged at four corners of one APD or arranged in each of a larger number of APDs. For example, the anode electrodes 302 may be arranged at four corners of every fourth pixel among pixels respectively including two APDs arranged in a 1 row×2 columns pattern. In addition, a part of the separation portion 324 may be formed in a separated manner so that the plurality of APDs share a common anode potential. In other words, a part of the semiconductor layer 300 may have a shape that is connected to an adjacent pixel in a plan view.

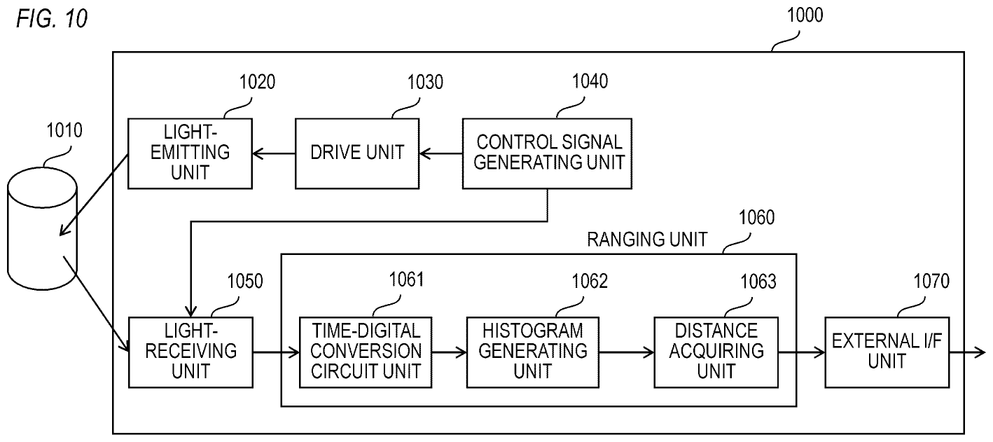

A functional configuration of a ranging apparatus 1000 will be described with reference to FIG. 10. FIG. 10 represents an example of a functional block diagram of the ranging apparatus 1000. The ranging apparatus 1000 includes a light-emitting unit 1020, a drive unit 1030, a control signal generating unit 1040, a light-receiving unit 1050, a ranging unit 1060, and an external I/F unit 1070. The ranging unit 1060 includes a time-digital conversion circuit (TDC) unit 1061, a histogram generating unit 1062, and a distance acquiring unit 1063.

The light-emitting unit 1020 is a light source such as an LED (Light-Emitting Diode) which irradiates an object 1010 that is a ranging object with light. The drive unit 1030 drives the light-emitting unit 1020 based on a control signal supplied from the control signal generating unit 1040. The control signal generating unit 1040 generates a control signal for driving the light-emitting unit 1020 in synchronization with a light reception timing of the light-receiving unit 1050 and transmits the control signal to the drive unit 1030. The light-receiving unit 1050 is the pixel region 12 (pixel array) and transmits, to the ranging unit 1060, signal information obtained by receiving reflected light of the light emitted from the light-emitting unit 1020.

The ranging unit 1060 acquires a distance to the object 1010 based on a difference among respective outputs of a plurality of subpixels having received the reflected light. Specifically, using the time-digital conversion circuit unit 1061, the histogram generating unit 1062, and the distance acquiring unit 1063, the ranging unit 1060 calculates a distance from the ranging apparatus 1000 to the object 1010 based on signal information of the reflected light received by the light-receiving unit 1050. In the present embodiment, the ranging unit 1060 is configured to perform ranging by the dToF system that involves measuring a time difference between the radiation of light and the detection of reflected light.

The time-digital conversion circuit unit 1061 converts the signal information of the reflected light into time information from the light-emitting unit 1020 radiating light to the light-receiving unit 1050 receiving reflected light. The histogram generating unit 1062 generates a histogram representing an intensity distribution of the reflected light with respect to a time from the start of radiation of light by the light-emitting unit 1020. For example, the intensity of reflected light is represented by the number of counted pulse signals detected from the reflected light. The histogram generating unit 1062 generates a histogram indicating a relationship between the time from light emission by the light-emitting unit 1020 and the count value (the number of counted pulse signals of reflected light).

The distance acquiring unit 1063 acquires a distance from the ranging apparatus 1000 to the object 1010 based on the histogram generated by the histogram generating unit 1062. Using a histogram representing the intensity of reflected light, the distance acquiring unit 1063 can acquire the distance to the object 1010 according to two systems, namely, the ToF system and the phase difference system.

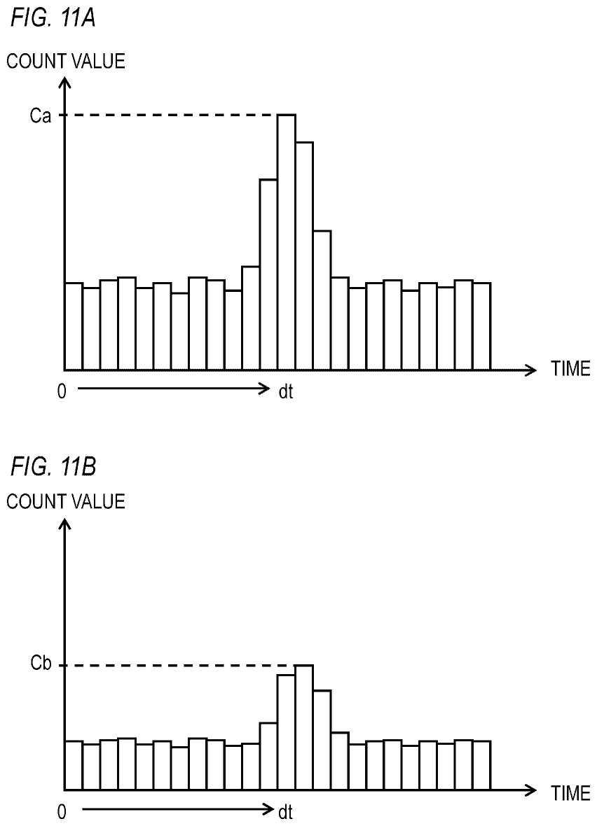

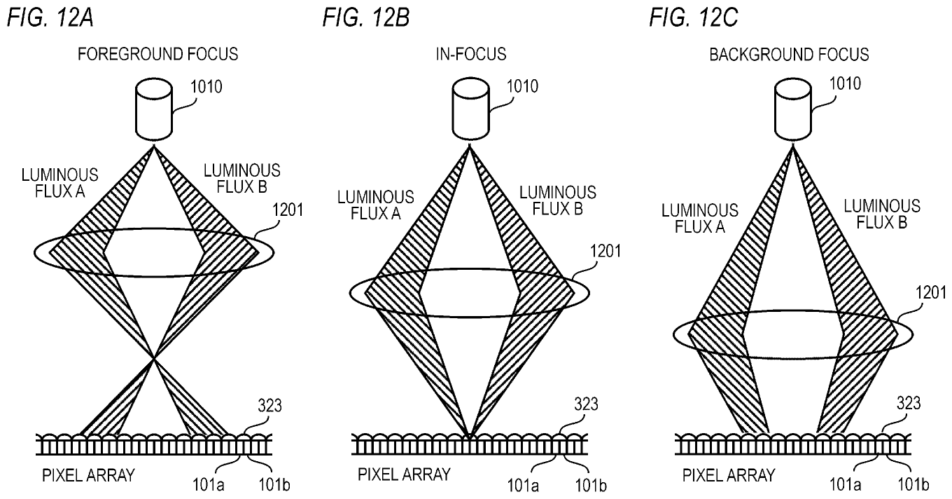

A method of calculating a distance to the object 1010 according to the two systems will be described with reference to FIGS. 11A and 11B and FIGS. 12A to 12C. FIGS. 11A and 11B are diagrams illustrating a histogram that represents an intensity of reflected light. A histogram representing the intensity of reflected light is generated during ranging according to the ToF system. FIGS. 12A to 12C are diagrams illustrating ranging by the phase difference system.

The ToF system is a system that acquires a distance to the object 1010 based on the time it takes for light radiated by the light-emitting unit 1020 to return after being reflected by the object 1010. The distance acquiring unit 1063 can acquire the time it takes for light to return after being reflected by the object 1010 from the histogram generated by the histogram generating unit 1062.

In the histograms shown in FIGS. 11A and 11B, an abscissa represents time from emission of light by the light-emitting unit 1020. An ordinate represents a count value of the pulse signal of reflected light received by the light-receiving unit 1050 at each time. The distance acquiring unit 1063 can acquire the distance to the object 1010 based on a time at which the intensity (count value) of reflected light peaks in the histograms.

In the histogram shown in FIG. 11A, a time dt at which the count value reaches a peak Ca is a time from the light-emitting unit 1020 radiating light to the light-receiving unit 1050 receiving reflected light having been reflected by the object 1010. In other words, the time dt represents a round-trip time from the radiation of light to the return of the light after being reflected by the object 1010. If the speed of light is denoted by c, then a distance D from the ranging apparatus 1000 to the object 1010 can be acquired by Expression 1 below.

$$D = c \times dt / 2 \qquad ( Expression 1 )$$

The phase difference system is a system in which each of a plurality of pixels (subpixels) included in an imaging element with a DAF function receives reflected light and a distance to an object is acquired based on a difference among respective outputs of the plurality of subpixels. The distance acquiring unit 1063 can acquire a distance to the object 1010 based on a phase difference of reflected light respectively received by the plurality of subpixels (a phase difference of a signal output from each pixel).

FIGS. 12A to 12C are diagrams describing ranging according to the phase difference system. FIGS. 12A to 12C show a configuration of receiving luminous fluxes A and B that pass through an imaging optical system 1201 by one microlens 323 and a pixel array in which a pixel 101 including the subpixel 101a and the subpixel 101b that share the microlens 323 is arranged in plurality.

FIG. 12A shows a state of foreground focus in which a foreground of the object 1010 as a subject is in focus. FIG. 12B shows a state where the object 1010 is in focus. FIG. 12C shows a state of background focus in which a background of the object 1010 is in focus. A defocus amount and a direction of deviation in an imaging plane phase difference AF (automatic focusing) system can be detected based on a phase difference between a signal of reflected light received by the subpixel 101a and a signal of reflected light received by the subpixel 101b. The distance acquiring unit 1063 can perform ranging to the subject (object 1010) based on the defocus amount and the direction of deviation in imaging plane phase difference AF.

In addition, the distance acquiring unit 1063 can detect a phase difference between the subpixel 101a and the subpixel 101b using a histogram generated during ranging according to the ToF system. For example, when the object 1010 is not in focus, the histograms of reflected light received by the subpixel 101a and the subpixel 101b become histograms with different intensities as shown in FIGS. 11A and 11B. This is because the light amounts received by the subpixel 101a and the subpixel 101b differ in a state of the foreground focus shown in FIG. 12A or in a state of the background focus shown in FIG. 12C. On the other hand, in the in-focus state shown in FIG. 12B, the subpixel 101a and the subpixel 101b receive light with more or less the same intensity. In this manner, by acquiring a difference in intensity of reflected light between two subpixels that share the microlens 323 within a predetermined range of the pixel array, the distance acquiring unit 1063 can detect a phase difference between the subpixel 101a and the subpixel 101b.

Note that the difference in intensity of reflected light may be a difference in intensity (count value) of reflected light at a peak of a histogram of each of a plurality of subpixels. In this case, the distance acquiring unit 1063 can detect a phase difference between the subpixel 101a and the subpixel 101b based on a difference between the intensity Ca of reflected light at the peak of the histogram of the subpixel 101a and the intensity Cb of reflected light at the peak of the histogram of the subpixel 101b.

In addition, the difference in intensity of reflected light may be a difference in a sum of intensities (count values) of reflected light of a histogram of each of a plurality of subpixels. In this case, the distance acquiring unit 1063 can detect a phase difference between the subpixel 101a and the subpixel 101b based on a difference between the sum of intensities of reflected light of the histogram of the subpixel 101a and the sum of intensities of reflected light of the histogram of the subpixel 101b. The sum of intensities of reflected light may be a sum of count values at a time in a predetermined range including a peak.

The external interface (I/F) unit 1070 shown in FIG. 10 is an interface for communicating with an external apparatus. The external I/F unit 1070 can output distance information to the object 1010 acquired by the ranging unit 1060 and the like to an external apparatus.

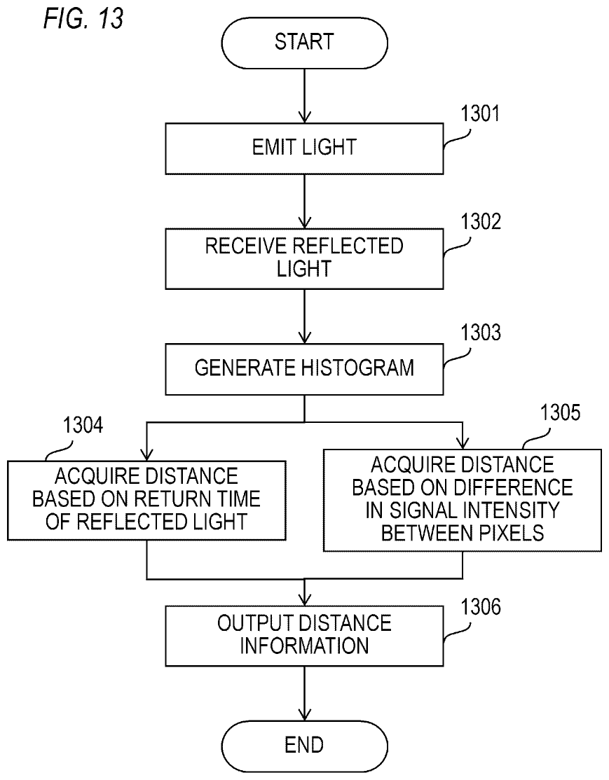

FIG. 13 is a flow chart illustrating ranging processing. In step S1301, the light-emitting unit 1020 irradiates the object 1010 with light. In step S1302, the light-receiving unit 1050 receives reflected light of the light irradiated in step S1301. In step S1303, the histogram generating unit 1062 generates a histogram indicating an intensity of reflected light for each of the subpixel 101a and the subpixel 101b having received reflected light with the light-receiving unit 1050.

In step S1304, the distance acquiring unit 1063 acquires a distance to the object 1010 based on a return time of the reflected light. In other words, the distance acquiring unit 1063 performs ranging by the ToF system. The distance acquiring unit 1063 may acquire a distance to the object 1010 using a part of a plurality of pixels that share the microlens 323. For example, the distance acquiring unit 1063 can acquire a distance to the object 1010 using the histogram of any one of the subpixel 101a and the subpixel 101b.

In addition, the distance acquiring unit 1063 may acquire a distance to the object 1010 based on output of a plurality of subpixels among the subpixels that share the microlens 323. For example, the distance acquiring unit 1063 can acquire the distance to the object 1010 based on a sum of intensities (count values) of reflected light among the respective histograms of two or more subpixels among the plurality of subpixels.

In step S1305, using the histogram generated in step S1303, the distance acquiring unit 1063 acquires the distance to the object 1010 based on a difference in signal intensity between pixels of the subpixel 101a and the subpixel 101b. In other words, the distance acquiring unit 1063 performs ranging by the phase difference system.

In step S1306, the distance acquiring unit 1063 (which corresponds to the output unit) outputs distance information regarding the distance to the object 1010 based on the distance to the object 1010 acquired in step S1304 and the distance to the object 1010 acquired in step S1305. The distance acquiring unit 1063 may respectively output the distances acquired by the two systems or may output the distance acquired by whichever system has had higher accuracy. In addition, the distance acquiring unit 1063 may output a distance produced by averaging or weighted-averaging the distances acquired by the two systems.

Furthermore, ranging according to each system has its advantages as well as disadvantages and, depending on predetermined conditions, the ranging according to one system may be more accurate than the ranging according to the other system. For example, the predetermined conditions include conditions such as the distance to the object 1010, a presence/absence of detection of reflected light, and a presence/absence of detection of contrast of the object 1010. Therefore, the distance acquiring unit 1063 may output a distance acquired by one of the systems in accordance with the predetermined conditions as the distance to the object 1010. Hereinafter, distance information that is output according to the predetermined conditions will be described.

When the distance to the object 1010 is greater than a predetermined threshold, the ToF system enables ranging to be performed with higher accuracy than the phase difference system. Therefore, when any of the distances to the object 1010 having been acquired by the two systems is longer than the predetermined threshold, the distance acquiring unit 1063 outputs the distance acquired by the ToF system in step S1304 as distance information. On the other hand, when both of the distances to the object 1010 having been acquired by the two systems are equal to or shorter than the predetermined threshold, the distance acquiring unit 1063 outputs the distance acquired by the phase difference system in step S1305 as distance information. Note that the predetermined threshold can be set in advance based on actual measurement results taken in each of the systems.

In addition, a method of comparing the predetermined threshold with the distances to the object 1010 acquired by the two systems is not limited to the method described above. For example, the distance acquiring unit 1063 may compare an average of the distances to the object 1010 acquired by the two systems with the predetermined threshold or may compare the distance to the object 1010 acquired by one of the two systems with the predetermined threshold.

In addition, when reflected light from the object 1010 is detected, the distance acquiring unit 1063 outputs the distance acquired by the ToF system in step S1304 as distance information. On the other hand, when reflected light from the object 1010 is not detected, the distance acquiring unit 1063 outputs the distance acquired by the phase difference system in step S1305 as distance information. A case where reflected light from the object 1010 is not detected is, for example, a case where radiated light is absorbed by the object 1010 or a case where reflected light from the object 1010 is not received due to an effect of ambient light.

Furthermore, when the distance to the object 1010 is obtained from a difference among respective outputs of a plurality of pixels that share the microlens 323, the distance acquiring unit 1063 outputs the distance acquired by the phase difference system in step S1305 as distance information. On the other hand, when the distance to the object 1010 is not obtained from a difference among respective outputs of a plurality of pixels that share the microlens 323, the distance acquiring unit 1063 outputs the distance acquired by the ToF system in step S1304 as distance information. A case where a phase difference is not detected from respective outputs of a plurality of pixels is, for example, when a contrast between the object 1010 and the background decreases.

According to the first embodiment described above, due to a configuration in which the plurality of subpixels 101a and 101b capable of ranging in the ToF system share one microlens 323, the ranging apparatus 1000 can also acquire information on a phase difference from information on a peak of a histogram and the like. In this manner, due to a simple configuration in which a plurality of subpixels share one microlens 323, the ranging apparatus 1000 realizes ranging by a plurality of systems and, at the same time, an increase in size of the ranging system can be suppressed.

Ranging according to the ToF system and ranging according to the phase difference system differ from each other in terms of an object of which ranging can be performed with accuracy and a situation where ranging can be performed with accuracy (a distance to the object, ambient light, and the like). Therefore, by combining ranging by these systems, the ranging apparatus 1000 can realize ranging with higher accuracy.

### Modification of First Embodiment

In a configuration in which a plurality of subpixels share one microlens 323, when performing ranging in the ToF system, the light intensity when each of the subpixels receive reflected light may differ. In consideration thereof, in a modification, in step S1304 in FIG. 13, the distance acquiring unit 1063 acquires a distance to the object 1010 using a subpixel with a largest output among the plurality of subpixels that share the microlens 323.

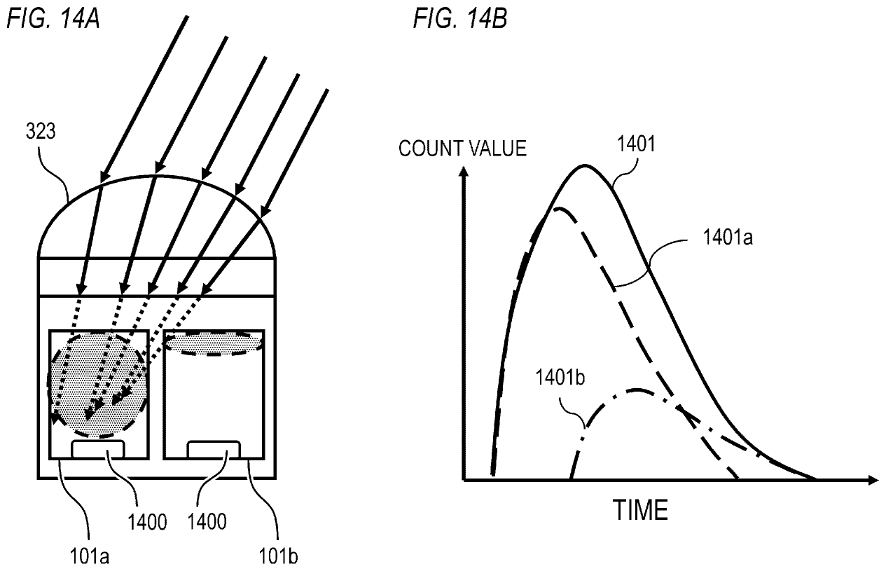

A timing jitter that occurs in ranging according to the ToF system due to the configuration in which a plurality of subpixels share one microlens 323 will now be described with reference to FIGS. 14A and 14B. As shown in FIG. 14A, an amount of incident light to the subpixel 101b is smaller than an amount of incident light to the subpixel 101a. In the subpixel 101b, since a photoelectric conversion occurs near an incidence surface, a movement distance of electrons to an avalanche region 1400 where an avalanche multiplication occurs may increase and timing jitter (a fluctuation of timings on a time axis of a signal waveform) may deteriorate.

In consideration thereof, the distance acquiring unit 1063 acquires a distance to the object 1010 based on the output of the subpixel 101a of which an amount of incident light is larger than the subpixel 101b and of which an output increases. For example, a subpixel with a largest output can be considered a subpixel of which a count value at a peak of a histogram or a sum of count values of the histogram is largest.

FIG. 14B shows a histogram 1401a of the subpixel 101a, a histogram 1401b of the subpixel 101b, and a histogram 1401 of the pixel 101 (a sum of the histogram 1401a and the histogram 1401b). In the subpixel 101b, an arrival time of an electron at the avalanche region 1400 is later than in the subpixel 101a. By not taking the histogram 1401b of the subpixel 101b into consideration and by acquiring the distance to the object 1010 using the histogram 1401a of the subpixel 101a, the distance acquiring unit 1063 can suppress an effect of timing jitter.

In the modification of the first embodiment, by acquiring the distance to the object 1010 using a subpixel with a largest output among the plurality of subpixels that share the microlens 323, the ranging apparatus 1000 can suppress an effect of timing jitter.

Note that the ranging apparatus 1000 is not limited to a case of performing ranging based on the output of any one subpixel among a plurality of subpixel and may acquire the distance to the object 1010 based on a histogram generated by weighting outputs of the plurality of subpixels. For example, the ranging apparatus 1000 may perform weighting based on a ratio of sums of count values of the respective subpixels.

### Second Embodiment

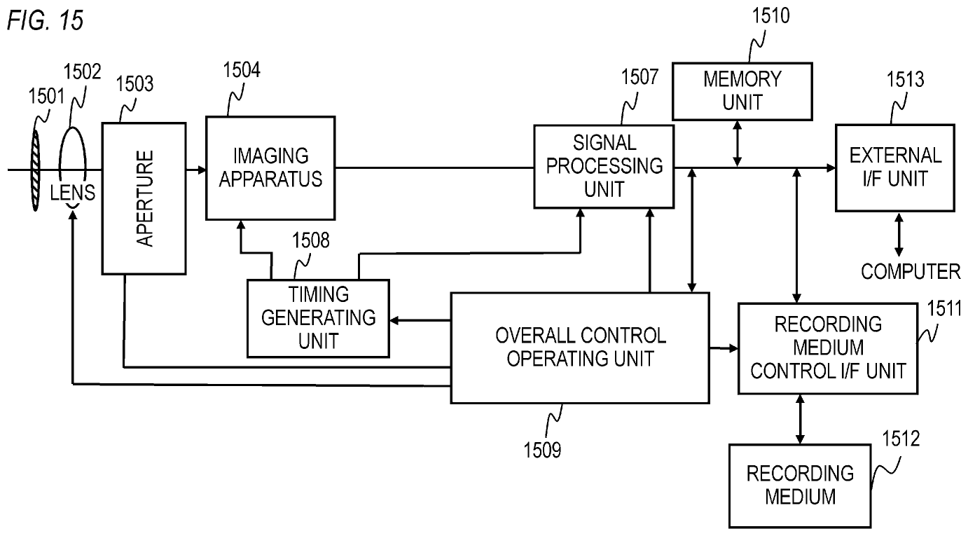

A ranging system according to the present embodiment will be described with reference to FIG. 15. FIG. 15 is a block diagram showing a schematic configuration of the ranging system according to the present embodiment.

The photoelectric conversion apparatus (ranging apparatus) described in the first embodiment can be applied to various ranging systems and can measure a distance to an object that is a ranging object such as a subject. The ranging system includes at least the ranging apparatus according to the embodiment described above and a signal processing unit that processes signals output from the ranging apparatus. Examples of devices to which such a ranging system can be applied include a digital still camera, a digital camcorder, a monitoring camera, a copier, a facsimile, a mobile phone, a vehicle-mounted camera, an observation satellite, a sensor, and a measuring instrument. In addition, camera modules provided with an optical system such as a lens and an imaging apparatus are also included in devices to which a ranging system is applied. FIG. 15 illustrates a block diagram of a digital still camera as an example of such devices.

The ranging system illustrated in FIG. 15 has an imaging apparatus 1504 to which a ranging apparatus that is an example of the photoelectric conversion apparatus has been applied and a lens 1502 that causes an optical image of a subject to be formed on the imaging apparatus 1504. In addition, the ranging system has an aperture 1503 for making a light amount that passes through the lens 1502 variable and a barrier 1501 for protecting the lens 1502. The lens 1502 and the aperture 1503 are optical systems for collecting light to the imaging apparatus 1504. The imaging apparatus 1504 is the photoelectric conversion apparatus (ranging apparatus) according to the first embodiment described above and converts an optical image having been formed by the lens 1502 into an electric signal.

The ranging system also has a signal processing unit 1507 that is an image generating unit for generating an image by processing an output signal that is output from the imaging apparatus 1504. The signal processing unit 1507 performs operations in which the output signal is subjected to various corrections and compression when necessary and image data is output. The signal processing unit 1507 may be formed on a semiconductor substrate provided with the imaging apparatus 1504 or formed on a semiconductor substrate that is separate from the imaging apparatus 1504. In addition, the imaging apparatus 1504 and the signal processing unit 1507 may be formed on a same semiconductor substrate.

The ranging system further has a memory unit 1510 for temporarily storing image data and an external interface unit (an external I/F unit) 1513 for communicating with an external computer or the like. Furthermore, the ranging system has a recording medium 1512 such as a semiconductor memory for recording or reading imaging data and a recording medium control interface unit (a recording medium control I/F unit) 1511 for performing recording or reading with respect to the recording medium 1512. The recording medium 1512 may be built into the ranging system or may be attachable to and detachable from the ranging system.

Furthermore, the ranging system has an overall control operating unit 1509 that performs various arithmetic operations and controls the entire digital still camera and a timing generating unit 1508 that outputs various timing signals to the imaging apparatus 1504 and the signal processing unit 1507. In this case, the timing signals and the like may be input from outside and the ranging system need at least have the imaging apparatus 1504 and the signal processing unit 1507 that processes an output signal that is output from the imaging apparatus 1504.

The imaging apparatus 1504 outputs an imaging signal to the signal processing unit 1507. The signal processing unit 1507 performs predetermined signal processing on the imaging signal output from the imaging apparatus 1504 and outputs image data. The signal processing unit 1507 generates an image using the imaging signal.

As described above, according to the present embodiment, a ranging system to which the photoelectric conversion apparatus (ranging apparatus) according to the first embodiment described above is applied can be realized.

### Third Embodiment

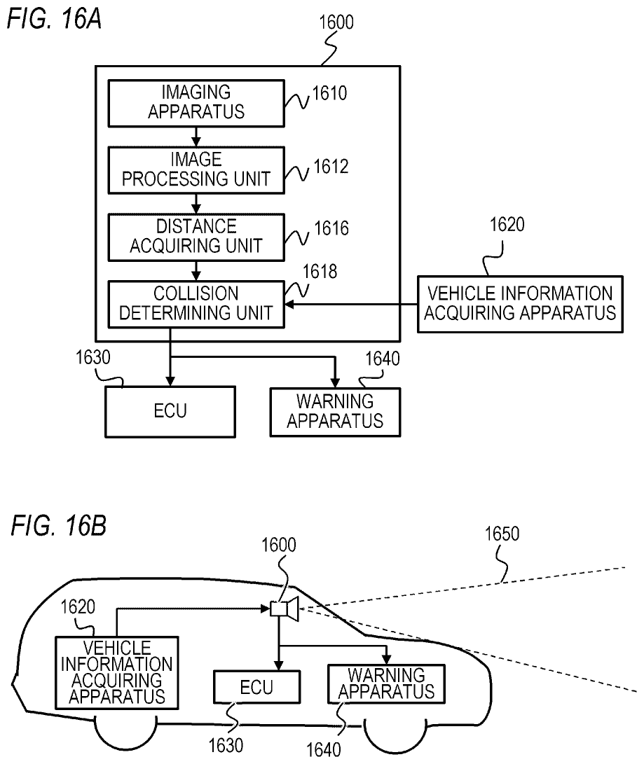

A ranging system and a moving body according to the present embodiment will be described with reference to FIGS. 16A and 16B. FIG. 16A is a diagram showing a configuration of the ranging system according to the present embodiment and FIG. 16B is a diagram showing a configuration of the moving body according to the present embodiment.

FIG. 16A shows an example of a ranging system related to a vehicle-mounted camera. A ranging system 1600 includes an imaging apparatus 1610 to which the photoelectric conversion apparatus (ranging apparatus) described in the first embodiment described above is applied. The ranging system 1600 has an image processing unit 1612 that performs image processing on a plurality of pieces of image data acquired by the imaging apparatus 1610. In addition, the ranging system 1600 has a distance acquiring unit 1616 that calculates a distance to an object and a collision determining unit 1618 that determines whether or not there is a possibility of a collision based on the calculated distance. In this case, the distance acquiring unit 1616 may acquire information on the distance to the object based on a ToF (Time of Flight) or may acquire distance information using parallax information or the like. Furthermore, the distance acquiring unit 1616 may acquire distance information by combining ranging according to ToF and ranging based on a phase difference between pixels. In other words, distance information is information related to a parallax, a defocus amount, a distance to the object, or the like. The collision determining unit 1618 may determine a possibility of a collision using any of these pieces of distance information. The distance information acquiring means may be realized by exclusively-designed hardware or may be realized by a software module. Alternatively, the distance information acquiring means may be realized by an FPGA (Field Programmable Gate Array), an ASIC (Application Specific Integrated Circuit), or the like, or a combination thereof.

The ranging system 1600 is connected to a vehicle information acquiring apparatus 1620 and is capable of acquiring vehicle information such as a vehicle speed, a yaw rate, and a steering angle. In addition, an ECU 1630 which is a control apparatus that outputs a control signal causing a vehicle to generate a braking force based on a determination result of the collision determining unit 1618 is connected to the ranging system 1600. Furthermore, the ranging system 1600 is also connected to a warning apparatus 1640 that issues a warning to a driver based on a determination result of the collision determining unit 1618. For example, when it is found that the possibility of a collision is high as a determination result of the collision determining unit 1618, the ECU 1630 performs vehicle control involving applying the brakes, releasing the gas pedal, suppressing engine output, or the like to avoid a collision and/or reduce damage. The warning apparatus 1640 issues a warning to a user by sounding an alarm, displaying warning information on a screen of a car navigation system or the like, vibrating a seat belt or a steering wheel, or the like.

In the present embodiment, an image of a periphery of the vehicle such as the front or the rear of the vehicle is picked up by the ranging system 1600. FIG. 16B shows the ranging system when imaging of the front of the vehicle (an imaging range 1650) is performed. The vehicle information acquiring apparatus 1620 sends an instruction to the ranging system 1600 or the imaging apparatus 1610. According to such a configuration, accuracy of ranging can be further improved.

While an example of controlling a vehicle so as to prevent a collision with another vehicle has been described above, the ranging system can also be applied to controlling automated driving so that the vehicle follows another vehicle, controlling automated driving so that the vehicle stays within a lane, and the like. In addition, the ranging system is not limited to a vehicle such as an automobile and can also be applied to a moving body (moving apparatus) such as a ship, an airplane, or an industrial robot. The moving body includes one of or both of a driving force generating unit that generates a driving force mainly used for movement of the moving body and a rotating member that is mainly used for movement of the moving body. The driving force generating unit can be an engine, a motor, or the like. The rotating member can be a tire, a wheel, a screw of a ship, a propeller of a flight vehicle, or the like. Moreover, besides moving bodies, the ranging system can be applied to a wide variety of devices that utilize object recognition such as an intelligent transportation system (ITS).

### Fourth Embodiment

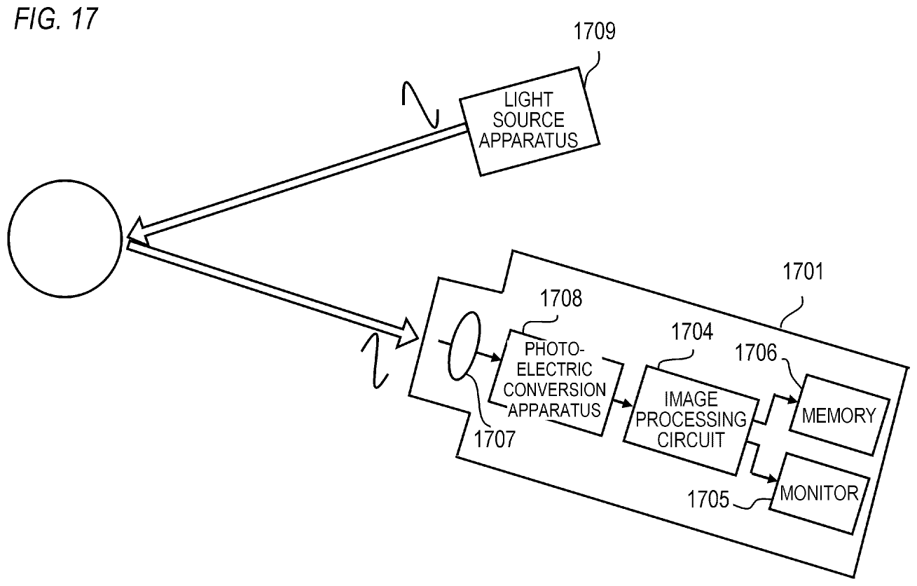

A ranging system according to the present embodiment will be described with reference to FIG. 17. FIG. 17 is a block diagram showing a configuration example of a distance image sensor that is the ranging system according to the present embodiment.

As shown in FIG. 17, a distance image sensor 1701 is configured to include an optical system 1707, a photoelectric conversion apparatus 1708, an image processing circuit 1704, a monitor 1705, and a memory 1706. In addition, the distance image sensor 1701 is capable of acquiring a distance image in accordance with a distance to a subject by receiving light (modulated light or pulsed light) emitted toward the subject from a light source apparatus 1709 and reflected by a surface of the subject.

The optical system 1707 is configured with one or a plurality of lenses and guides image light (incident light) from the subject to the photoelectric conversion apparatus 1708 and forms an image on a light-receiving surface (a sensor unit) of the photoelectric conversion apparatus 1708.

The photoelectric conversion apparatus (ranging apparatus) according to the first embodiment described above is applied as the photoelectric conversion apparatus 1708 and a distance signal indicating a distance obtained from a light reception signal output from the photoelectric conversion apparatus 1708 is supplied to the image processing circuit 1704.

The image processing circuit 1704 performs image processing for constructing a distance image based on the distance signal supplied from the photoelectric conversion apparatus 1708. In addition, a distance image (image data) obtained by the image processing is supplied to and displayed by the monitor 1705 or supplied to and stored (recorded) in the memory 1706.

With the distance image sensor 1701 configured as described above, applying the photoelectric conversion apparatus (ranging apparatus) according to the first embodiment described above enables, for example, a more accurate distance image to be acquired due to an improvement in ranging accuracy.

### Fifth Embodiment

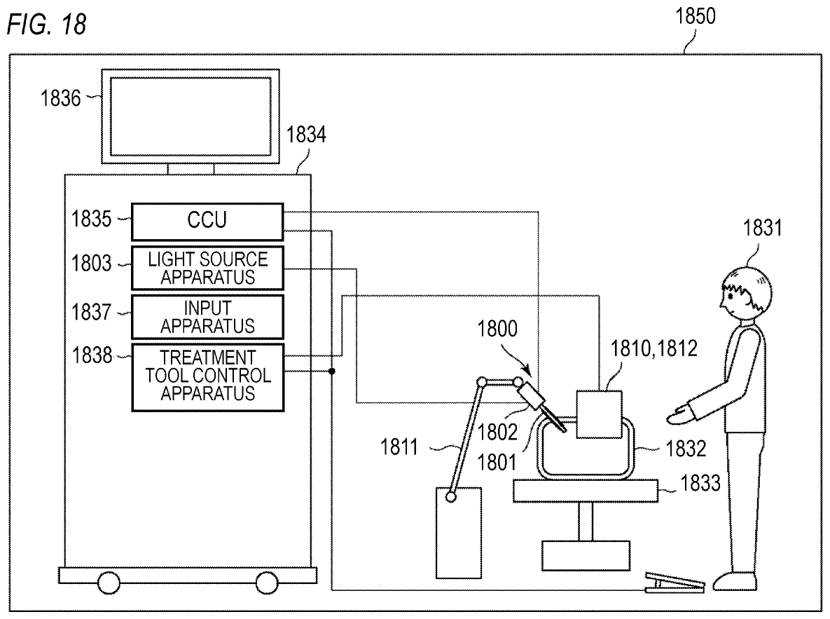

A ranging system according to the present embodiment will be described with reference to FIG. 18. FIG. 18 is a diagram showing an example of a schematic configuration of an endoscopic surgery system that is the ranging system according to the present embodiment.

FIG. 18 illustrates a situation where a technician (a physician) 1831 is using an endoscopic surgery system 1850 to operate on a patient 1832 on a patient bed 1833. As illustrated, the endoscopic surgery system 1850 is constituted of an endoscope 1800, a surgical instrument 1810, and a cart 1834 mounted with various apparatuses for an endoscopic surgery.

The endoscope 1800 is constituted of a lens barrel 1801 of which a region with a predetermined length from a distal end is to be inserted into a body cavity of the patient 1832 and a camera head 1802 connected to a base end of the lens barrel 1801. While the illustrated example features the endoscope 1800 being configured as a so-called rigid scope having a rigid lens barrel 1801, alternatively, the endoscope 1800 may be configured as a so-called flexible scope having a flexible lens barrel.

An opening into which an objective lens is fitted is provided at the distal end of the lens barrel 1801. A light source apparatus 1803 is connected to the endoscope 1800, and light generated by the light source apparatus 1803 is guided to the distal end of the lens barrel 1801 by a light guide provided so as to extend inside the lens barrel and emitted toward an observation object inside a body cavity of the patient 1832 via the objective lens. It should be noted that the endoscope 1800 may be a forward-viewing endoscope, an oblique-viewing endoscope, or a side-viewing endoscope.

An optical system and a photoelectric conversion apparatus are provided inside the camera head 1802 and reflected light (observation light) from the observation object is collected to the photoelectric conversion apparatus by the optical system. The observation light is photoelectrically converted by the photoelectric conversion apparatus and an electric signal corresponding to the observation light or, in other words, an image signal corresponding to an observed image is generated. As the photoelectric conversion apparatus, the photoelectric conversion apparatus (ranging apparatus) according to the first embodiment described above can be used. The image signal is transmitted to a Camera Control Unit (CCU) 1835 as RAW data.

The CCU 1835 is constituted of a CPU (Central Processing Unit), a GPU (Graphics Processing Unit), or the like and comprehensively controls operations of the endoscope 1800 and a display apparatus 1836. In addition, the CCU 1835 receives an image signal from the camera head 1802 and subjects the image signal to various kinds of image processing for displaying an image based on the image signal such as development processing (demosaicing).

Under control exerted by the CCU 1835, the display apparatus 1836 displays an image based on the image signal subjected to image processing by the CCU 1835.

The light source apparatus 1803 is constituted of a light source such as an LED (Light-Emitting Diode) and supplies the endoscope 1800 with irradiation light used when photographing a surgical site or the like.

An input apparatus 1837 is an input interface with respect to the endoscopic surgery system 1850. A user can input various kinds of information and input instructions to the endoscopic surgery system 1850 via the input apparatus 1837.

A treatment tool control apparatus 1838 controls drive of an energy treatment tool 1812 for cauterizing or incising tissue, sealing a blood vessel, or the like.

The light source apparatus 1803 that supplies the endoscope 1800 with irradiation light when photographing a surgical site can be constituted of a white light source constituted of an LED, a laser light source, or a combination thereof. When the white light source is constituted of a combination of RGB laser light sources, since output intensity and an output timing of each color (each wavelength) can be controlled with high accuracy, white balance of a captured image can be adjusted in the light source apparatus 1803. In addition, in this case, an image corresponding to each of RGB can be captured in a time-divided manner by having an observation object be irradiated with laser light from each of the RGB laser light sources in a time-divided manner and controlling drive of an imaging element of the camera head 1802 in synchronization with the irradiation timing. According to this method, a color image can be obtained without having to provide the imaging element with a color filter.

In addition, drive of the light source apparatus 1803 may be controlled such that intensity of output light changes at predetermined intervals. By controlling drive of imaging elements of the camera head 1802 in synchronization with a timing at which the intensity of light changes to acquire images in a time-divided manner and compositing the images, an image with a high dynamic range that is free of so-called blocked-up shadows and blown-out highlights can be generated.

Furthermore, the light source apparatus 1803 may be configured to be capable of supplying light in a predetermined wavelength band that accommodates special light observation. In special light observation, for example, wavelength dependence of absorption of light by body tissue is utilized. Specifically, predetermined tissue such as a blood vessel of a superficial portion of a mucous membrane is photographed with high contrast by irradiating light with a narrower band than irradiation light during normal observation (in other words, white light). Alternatively, in special light observation, fluorescent observation may be performed in which an image is obtained using fluorescent light generated by irradiating excitation light. In fluorescent observation, body tissue may be irradiated with excitation light and fluorescent light from the body tissue can be observed, a reagent such as indocyanine green (ICG) can be locally injected into body tissue and the body tissue can be irradiated with excitation light corresponding to a fluorescent wavelength of the reagent to obtain a fluorescent image, and the like. The light source apparatus 1803 may be configured to be capable of supplying narrow-band light and/or excitation light that accommodates such special light observation.

### Sixth Embodiment

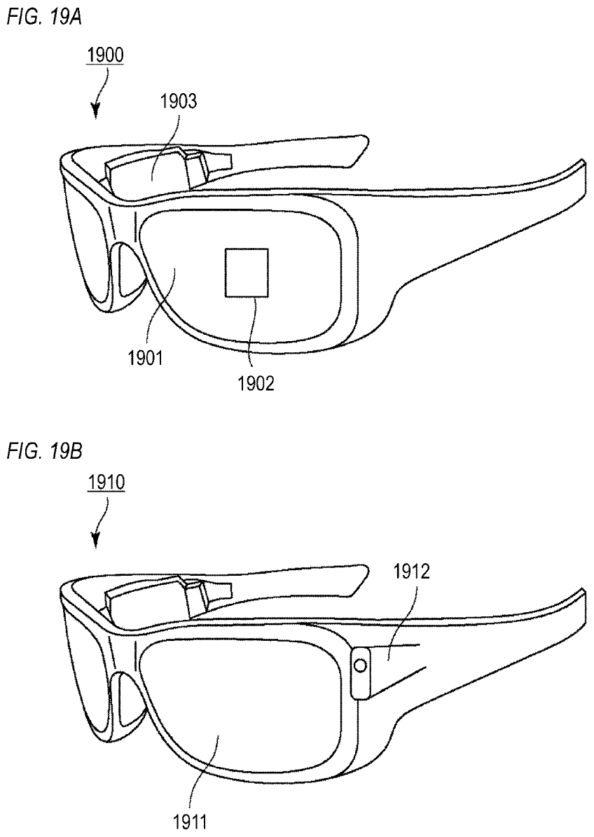

A ranging system according to the present embodiment will be described with reference to FIGS. 19A and 19B. FIG. 19A illustrates eyeglasses 1900 (smart glasses) that is the ranging system according to the present embodiment. The eyeglasses 1900 have a photoelectric conversion apparatus 1902. The photoelectric conversion apparatus 1902 is the photoelectric conversion apparatus (ranging apparatus) according to the first embodiment described above. In addition, a display apparatus including a light-emitting apparatus such as an OLED or an LED may be provided on a rear surface side of a lens 1901. There may be one or a plurality of photoelectric conversion apparatuses 1902. Alternatively, a plurality of types of photoelectric conversion apparatuses may be used in combination. An arrangement position of the photoelectric conversion apparatus 1902 is not limited to that shown in FIG. 19A.

The eyeglasses 1900 further include a control apparatus 1903. The control apparatus 1903 functions as a power source that supplies power to the photoelectric conversion apparatus 1902 and the display apparatus described above. In addition, the control apparatus 1903 controls operations of the photoelectric conversion apparatus 1902 and the display apparatus. An optical system for collecting light to the photoelectric conversion apparatus 1902 is formed in the lens 1901.

FIG. 19B illustrates eyeglasses 1910 (smart glasses) according to one application example. The eyeglasses 1910 include a control apparatus 1912 and the control apparatus 1912 is mounted with a photoelectric conversion apparatus that corresponds to the photoelectric conversion apparatus 1902 and a display apparatus. An optical system for projecting light emitted from the photoelectric conversion apparatus inside the control apparatus 1912 and the display apparatus is formed in the lens 1911 and an image is projected onto the lens 1911. The control apparatus 1912 functions as a power source that supplies power to the photoelectric conversion apparatus and the display apparatus and, at the same time, controls operations of the photoelectric conversion apparatus and the display apparatus. The control apparatus may have a line-of-sight detecting unit that detects a line-of-sight of a wearer. Infrared light may be used to detect a line-of-sight. An infrared light-emitting unit emits infrared light to the eyes of a user who is looking at a display image. A picked-up image of the eyes can be obtained by having an imaging unit including a light-receiving element detect reflected light from the eyes of emitted infrared light. Providing reducing means that reduces light from the infrared light-emitting unit to the display unit in a plan view enables a decline in image quality to be mitigated.

A line-of-sight of the user with respect to a display image can be detected from a picked-up image of eyes obtained by imaging with infrared light. Any known method can be applied to line-of-sight detection using a picked-up image of the eyes. For example, a line-of-sight detection method based on a Purkinje image due to reflection of irradiation light by the cornea can be used.

More specifically, line-of-sight detection processing based on a pupil-corneal reflection method is performed. Using the pupil-corneal reflection method, a line-of-sight of a user is detected by calculating a line-of-sight vector that represents an orientation (a rotation angle) of the eyes based on an image of a pupil included in a picked-up image of the eyes and a Purkinje image.

The display apparatus according to the present embodiment may have a photoelectric conversion apparatus including a light-receiving element and a display image of the display apparatus may be controlled based on line-of-sight information of the user from the photoelectric conversion apparatus.

Specifically, the display apparatus determines, based on the line-of-sight information, a first field-of-view region which the user focuses on and a second field-of-view region other than the first field-of-view region. The first field-of-view region and the second field-of-view region may be determined by the control apparatus of the display apparatus or regions determined by an outside control apparatus may be received as the first field-of-view region and the second field-of-view region. In a display region of the display apparatus, a display resolution of the first field-of-view region may be controlled to be higher than a display resolution of the second field-of-view region. In other words, the resolution of the second field-of-view region may be set lower than that of the first field-of-view region.

In addition, the display region may have a first display region and a second display region that differs from the first display region, and a region with high priority may be determined from the first display region and the second display region based on line-of-sight information. The first display region and the second display region may be determined by the control apparatus of the display apparatus or regions determined by an outside control apparatus may be received as the first display region and the second display region. A resolution of a region with high priority may be controlled to be higher than a resolution of a region other than the region with high priority. In other words, a resolution of a region of which a priority is relatively low can be lowered.

It should be noted that an AI may be used to determine the first field-of-view region and a region with high priority. The AI may be a model configured to use an image of the eyes and a direction actually viewed by the eyes in the image as teacher data to estimate, from the image of the eyes, an angle of a line-of-sight and a distance to an object ahead of the line-of-sight. An AI program may be included in the display apparatus, the photoelectric conversion apparatus, or an external apparatus. When the external apparatus includes an AI program, an inference result by an AI is sent to the display apparatus via communication.

Display control based on visual recognition and detection can be preferably applied to smart glasses further including a photoelectric conversion apparatus that captures images of the outside. The smart glasses are capable of displaying captured external information in real-time.

### Seventh Embodiment

The photoelectric conversion apparatus (ranging apparatus) according to the first embodiment and the ranging systems described above can be applied to, for example, electronic devices such as so-called smartphones and tablets.

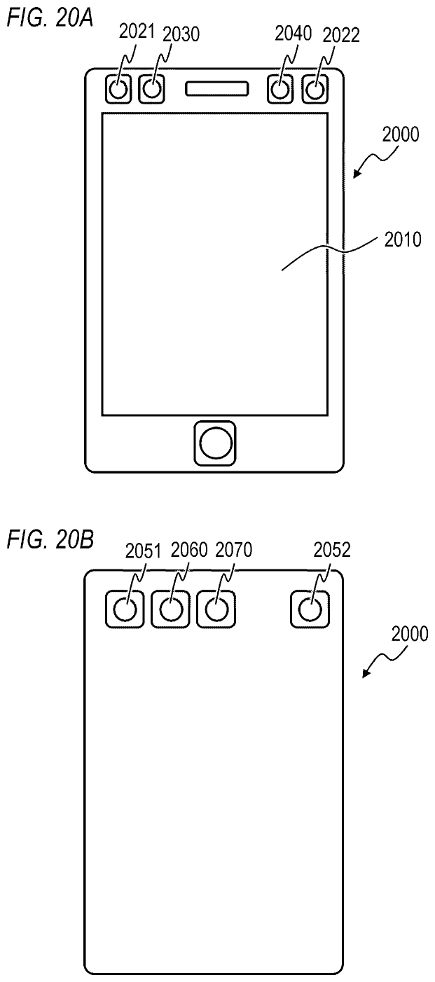

FIGS. 20A and 20B are diagrams showing an example of an electronic device 2000 to which a photoelectric conversion apparatus is mounted. FIG. 20A shows a front surface side of the electronic device 2000 and FIG. 20B shows a rear surface side of the electronic device 2000.

As shown in FIG. 20A, a display 2010 that displays an image is arranged at a center of the front surface of the electronic device 2000. In addition, front cameras 2021 and 2022 that use the photoelectric conversion apparatus, an IR light source 2030 that emits infrared light, and a visible light source 2040 that emits visible light are arranged along an upper side of the front surface of the electronic device 2000.

Furthermore, as shown in FIG. 20B, rear cameras 2051 and 2052 that use the photoelectric conversion apparatus, an IR light source 2060 that emits infrared light, and a visible light source 2070 that emits visible light are arranged along an upper side of the rear surface of the electronic device 2000.

In the electronic device 2000 configured as described above, by applying the photoelectric conversion apparatus described above, for example, an image with higher quality can be captured and a distance to a subject can be measured with high accuracy. Note that the photoelectric conversion apparatus can be applied to other electronic devices such as an infrared sensor, a ranging sensor using an active infrared light source, a security camera, and a personal authentication camera or a biometric camera. As a result, accuracy and performance of such electronic devices can be improved.

### Eighth Embodiment

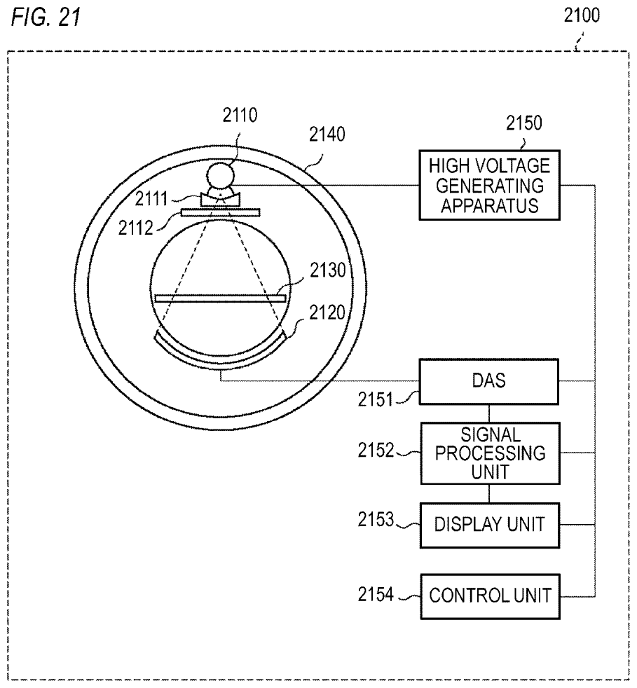

FIG. 21 is a block diagram of an X-ray CT apparatus according to the present embodiment. The photoelectric conversion apparatus (ranging apparatus) according to the first embodiment and the ranging systems described above can be applied to a detector of the X-ray CT apparatus. An X-ray CT apparatus 2100 according to the present embodiment includes an X-ray generating unit 2110, a wedge 2111, a collimator 2112, an X-ray detecting unit 2120, and a top plate 2130. Furthermore, the X-ray CT apparatus 2100 includes a rotating frame 2140, a high voltage generating apparatus 2150, a data collection apparatus (DAS: Data Acquisition System) 2151, a signal processing unit 2152, a display unit 2153, and a control unit 2154.

The X-ray generating unit 2110 is constituted of, for example, a vacuum tube that generates X-rays. A high voltage from the high voltage generating apparatus 2150 and a filament current are supplied to the vacuum tube of the X-ray generating unit 2110. An X-ray is generated as thermions are radiated from a cathode (filament) toward an anode (target).

The wedge 2111 is a filter that adjusts an X-ray dosage radiated from the X-ray generating unit 2110. The wedge 2111 attenuates the X-ray dosage so that X-rays radiated from the X-ray generating unit 2110 toward the object are distributed as determined in advance. The collimator 2112 is constituted of a lead plate or the like that narrows down an irradiation range of the X-rays having passed through the wedge 2111. An X-ray generated by the X-ray generating unit 2110 is molded into a cone beam shape via the collimator 2112 and radiated to the object on the top plate 2130.

The X-ray detecting unit 2120 is constructed by using the photoelectric conversion apparatus or the ranging system described above. The X-ray detecting unit 2120 detects an X-ray having passed through the object from the X-ray generating unit 2110 and outputs a signal corresponding to the X-ray dosage to the DAS 2151.

The rotating frame 2140 has an annular shape and is configured to be rotatable. The X-ray generating unit 2110 (the wedge 2111 and the collimator 2112) and the X-ray detecting unit 2120 are arranged so as to oppose each other inside the rotating frame 2140. The X-ray generating unit 2110 and the X-ray detecting unit 2120 are rotatable together with the rotating frame 2140.

The high voltage generating apparatus 2150 includes a boost circuit and outputs a high voltage to the X-ray generating unit 2110. The DAS 2151 includes an amplifier circuit and an A/D converter circuit and outputs a signal from the X-ray detecting unit 2120 as digital data to the signal processing unit 2152.

The signal processing unit 2152 includes a CPU (Central Processing Unit), a ROM (Read Only Memory), and a RAM (Random Access Memory) and is capable of executing image processing of digital data and the like. The display unit 2153 includes a flat display apparatus or the like and is capable of displaying an X-ray image. The control unit 2154 includes a CPU, a ROM, and a RAM and controls operations of the entire X-ray CT apparatus 2100.

### Ninth Embodiment

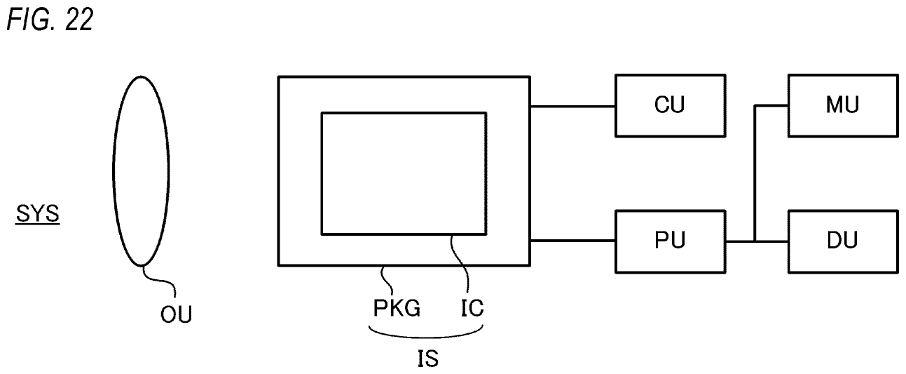

A ranging system according to a ninth embodiment will be described with reference to FIG. 22. FIG. 22 is a block diagram showing a schematic configuration of an imaging system SYS that is the ranging system according to the ninth embodiment. The imaging system SYS includes at least the ranging apparatuses according to the embodiments described above and a signal processing unit that processes signals output from the ranging apparatus.

The imaging system SYS is an information terminal that includes a camera and a photography function. The imaging system SYS is constructed using an imaging apparatus IS. The imaging apparatus IS can further include a package PKG that houses an imaging device IC. The package PKG can include a substrate on which the imaging device IC is fixed and a lid body that opposes the imaging device IC. The package PKG can include a connecting member (a member that connects a terminal provided on the substrate and a terminal provided on the imaging device IC) to each other. The imaging apparatus IS can mount a plurality of the imaging devices IC to a common package PKG by arranging the imaging devices IC side by side. Alternatively, the imaging apparatus IS can mount the imaging device IC and another semiconductor device IC to a common package PKG by stacking the imaging device IC and the semiconductor device IC on top of each other.

The imaging system SYS can include an optical system OU (optical apparatus) that forms an image on the imaging apparatus IS. In addition, the imaging system SYS can include at least any of a control apparatus CU, a processing apparatus PU, a display apparatus DU, and a storage apparatus MU. The control apparatus CU controls the imaging apparatus IS and the processing apparatus PU processes a signal obtained from the imaging apparatus IS. Furthermore, the display apparatus DU displays an image obtained from the imaging apparatus IS and the storage apparatus MU stores the image obtained from the imaging apparatus IS.

### Other Embodiments

While various devices have been explained in the embodiments described above, a mechanical apparatus may be further provided. A mechanical apparatus in a camera can drive parts of the optical system for the purposes of zooming, focusing, and shutter operations. Alternatively, the mechanical apparatus in the camera can move the photoelectric conversion apparatus for vibration insulation.

In addition, the device may be transportation equipment such as a vehicle, a ship, or a flight vehicle. A mechanical apparatus in the transportation equipment may be used as a moving apparatus. The device as transportation equipment is suitable as a device that transports the photoelectric conversion apparatus or a device that assists and/or automates driving (operation) using the photography function. A processing apparatus for assisting and/or automating driving (operation) can perform processing for operating the mechanical apparatus as a moving apparatus based on information obtained by the photoelectric conversion apparatus.

The embodiments described above can be appropriately modified without departing from the technical concepts of the invention. It is to be understood that disclosed contents of the present specification include not only matters described in the present specification but also all matters that may be comprehended from the present specification and from the drawings that accompany the present specification. In addition, disclosed contents of the present specification include complementary sets of concepts described in the present specification. In other words, supposing that the present specification includes a description reading, for example, “A is larger than B”, it is assumed that the present specification also discloses that “A is not larger than B” even though a description of “A is not larger than B” has been omitted. This is because, the presence of a description to the effect that “A is larger than B” is premised on the fact that a case where “A is not larger than B” is being taken into consideration.

In the present specification, there may be cases where expressions such as “A or B”, “at least one of A and B”, “at least one of A and/or B”, “one or more of A and/or B”, and the like are used. In such a case, all possible combinations of the listed items can be included unless explicitly defined otherwise. In other words, the expressions presented above are understood to disclose all of a case where at least one A is included, a case where at least one B is included, and a case where both at least one A and at least one B are included. This logic is similarly applied to combinations of three or more elements.

According to the present invention, ranging according to a ToF system and a phase difference system can be realized and ranging accuracy can be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-169491, filed on Sep. 29, 2023, which is hereby incorporated by reference herein in its entirety.

What is claimed is:

1. A ranging apparatus comprising:
a light-emitting unit configured to irradiate an object with light;
a plurality of pixels;
a microlens that is arranged on the plurality of pixels and that is shared by the plurality of pixels;
a first ranging unit configured to acquire a distance to the object, based on a time it takes to receive reflected light of the light radiated by the light-emitting unit; and
a second ranging unit configured to acquire a distance to the object, based on a difference among respective outputs of the plurality of pixels having received the reflected light.

2. The ranging apparatus according to claim 1, wherein
the first ranging unit acquires the distance to the object by using a part of the plurality of pixels.

3. The ranging apparatus according to claim 2, wherein
the first ranging unit acquires the distance to the object by using a pixel with a largest output among the plurality of pixels.

4. The ranging apparatus according to claim 1, further comprising
a generating unit configured to generate a histogram representing an intensity distribution of the reflected light with respect to a time from start of radiation of the light by the light-emitting unit.

5. The ranging apparatus according to claim 4, wherein
an intensity of the reflected light is represented by a number of counted pulse signals detected from the reflected light.

6. The ranging apparatus according to claim 4, wherein
the first ranging unit acquires the distance to the object, based on a time at which intensity of the reflected light peaks in the histogram.

7. The ranging apparatus according to claim 4, wherein
the first ranging unit acquires the distance to the object, based on a sum of intensities of the reflected light among the respective histograms of two or more pixels among the plurality of pixels.

8. The ranging apparatus according to claim 4, wherein
the second ranging unit acquires the distance to the object, based on a difference between an intensity of the reflected light at a peak of the histogram of a first pixel among the plurality of pixels and an intensity of the reflected light at a peak of the histogram of a second pixel among the plurality of pixels.

9. The ranging apparatus according to claim 4, wherein
the second ranging unit acquires the distance to the object, based on a difference between a sum of intensities of the reflected light of the histogram of a first pixel among the plurality of pixels and a sum of intensities of the reflected light of the histogram of a second pixel among the plurality of pixels.

10. The ranging apparatus according to claim 1, further comprising
an output unit configured to output distance information regarding a distance to the object, based on a first distance that is a distance to the object acquired by the first ranging unit and a second distance that is a distance to the object acquired by the second ranging unit.

11. The ranging apparatus according to claim 10, wherein the output unit
outputs the first distance as the distance information in a case where the first distance or the second distance is longer than a predetermined threshold, and
outputs the second distance as the distance information in a case where the first distance and the second distance are equal to or shorter than the predetermined threshold.

12. The ranging apparatus according to claim 10, wherein the output unit
outputs the first distance as the distance information in a case where the reflected light from the object is detected, and
outputs the second distance as the distance information in a case where the reflected light from the object is not detected.

13. The ranging apparatus according to claim 10, wherein the output unit
outputs the second distance as the distance information in a case where a distance to the object is obtained from a difference among respective outputs of the plurality of pixels, and
outputs the first distance as the distance information in a case where a distance to the object is not obtained from a difference among respective outputs of the plurality of pixels.

14. The ranging apparatus according to claim 1, wherein
each of the plurality of pixels includes an avalanche photodiode.

15. A ranging system comprising:
the ranging apparatus according to claim 1; and
a signal processing unit configured to process a signal output by the ranging apparatus.

16. A moving body comprising the ranging apparatus according to claim 1, the moving body comprising
a control unit configured to control movement of the moving body using information on a distance to the object that is acquired by the ranging apparatus.

17. A device comprising:
the ranging apparatus according to claim 1; and at least any of
an optical apparatus that corresponds to the ranging apparatus,
a control apparatus that controls the ranging apparatus,
a processing apparatus that processes a signal output from the ranging apparatus,
a display apparatus that displays information obtained by the ranging apparatus,
a storage apparatus that stores information obtained by the ranging apparatus, and
a mechanical apparatus that operates based on information obtained by the ranging apparatus.
